(19) United States
(12) Patent Application Publication
(10) Pub. No.: US 2026/0173217 A1
(43) Pub. Date: Jun. 18, 2026

(54) ELECTRONIC WIND INSTRUMENT AND MOUNTING METHOD OF HEATING ELEMENT

(71) Applicant: Roland Corporation, Shizuoka (JP)

(72) Inventors: Hitoshi SATO, Hamamatsu (JP); Rin YAEGASHI, Hamamatsu (JP); Kentaro MORI, Hamamatsu (JP); Masato SHIMIZU, Hamamatsu (JP)

(73) Assignee: Roland Corporation, Shizuoka (JP)

(21) Appl. No.: 19/402,993

(22) Filed: Nov. 27, 2025

(30) Foreign Application Priority Data
Dec. 12, 2024 (JP) 2024-218224
Feb. 18, 2025 (JP) 2025-024415

(51) Int. Cl. H05B 3/22; G10H 1/32; G10H 3/14

(52) U.S. Cl. CPC H05B 3/22; G10H 1/32; G10H 3/14; G10H 2220/361; G10H 2220/461; G10H 2230/195

(57) ABSTRACT

Provided are an electronic wind instrument and a mounting method of a heating element. The electronic wind instrument includes a housing; an air inlet for exhaled air formed in the housing; a flow path extending from the air inlet to an interior of the housing; a sensor positioned in the flow path and configured to detect exhaled air; and a heating element configured to heat the flow path on an upstream side of the sensor.

### CROSS-REFERENCE TO RELATED APPLICATION

This application claims the priority benefit of Japan application serial no. 2024-218224, filed on Dec. 12, 2024 and the priority benefit of Japan application serial no. 2025-024415, filed on Feb. 18, 2025. The entirety of the above-mentioned patent application is hereby incorporated by reference herein and made a part of this specification.

### BACKGROUND

### Technical Field

The disclosure relates to an electronic wind instrument and a mounting method of a heating element, and particularly relates to an electronic wind instrument and a mounting method of a heating element that can improve detection accuracy of exhaled air.

### Description of Related Art

For example, Patent Document 1 (Japanese Patent Application Laid-Open Publication No. 2010-262077 (e.g., paragraphs 0009 to 00013, FIG. 1 to FIG. 3)) describes an electronic wind instrument in which an area partition member E is incorporated inside a pipe body P having a mouthpiece 1. The area partition member E is formed with a first breath introduction area 4 and a second breath introduction area 5 extending from the mouthpiece 1 to two sides in the axial direction of the pipe body P, and pressure sensors 8 and 9 for detecting exhaled air blown into the mouthpiece 1 are provided in the first and second breath introduction areas 4 and 5. Since the pressure sensors 8 and 9 are provided at the end portions in the axial direction of the first and second breath introduction areas 4 and 5, it is possible to suppress saliva contained in the performer's exhaled air from being directly blown onto the pressure sensors 8 and 9.

However, in the conventional technology described above, saliva contained in exhaled air or moisture generated by condensation of exhaled air may accumulate in the flow path between the mouthpiece 1 and the pressure sensors 8 and 9. In the case of such moisture retention occurs, in addition to the flow of exhaled air in the flow path being obstructed, the moisture retained in the flow path may flow due to the pressure of the exhaled air and adhere to the pressure sensors 8 and 9. Thus, there was a problem that the detection accuracy of exhaled air by the pressure sensors 8 and 9 deteriorated.

The disclosure provides an electronic wind instrument and a mounting method of a heating element that may improve detection accuracy of exhaled air.

### SUMMARY

The electronic wind instrument of the disclosure includes a housing; an air inlet for exhaled air formed in the housing; a flow path extending from the air inlet to an interior of the housing; a sensor positioned in the flow path and configured to detect exhaled air; and a heating element configured to heat the flow path on an upstream side of the sensor.

The mounting method of a heating element of the disclosure is a mounting method of a heating element in an electronic wind instrument that includes a housing, an air inlet for exhaled air formed in the housing; an air inlet for exhaled air formed in the housing; a flow path extending from the air inlet to an interior of the housing; and a sensor positioned in the flow path and configured to detect exhaled air, the mounting method of the heating element includes mounting a heating element that heats the flow path on an upstream side of the sensor to a wall that surrounds the flow path.

### BRIEF DESCRIPTION OF THE DRAWINGS

FIG. 1A is a perspective view of the electronic wind instrument of the first embodiment, and FIG. 1B is a partially enlarged perspective view of the electronic wind instrument showing a state in which the instrument body is disassembled.

FIG. 2 is an exploded perspective view of the air inlet unit.

FIG. 3A is a perspective view of the lip plate viewed from the inside, and FIG. 3B is a partially enlarged cross-sectional view of the air inlet unit.

FIG. 4 is a partially enlarged cross-sectional view of the air inlet unit taken along line IV-IV of FIG. 3B.

FIG. 5A is a partially enlarged cross-sectional view of the air inlet unit taken along line Va-Va of FIG. 4, and FIG. 5B is a partially enlarged cross-sectional view of the air inlet unit taken along line Vb-Vb of FIG. 4.

FIG. 6 is a partially enlarged cross-sectional view of the electronic wind instrument taken along line VI-VI of FIG. 1B.

FIG. 7A is a cross-sectional view of the electronic wind instrument taken along line VIIa-VIIa of FIG. 6, and FIG. 7B is a partially enlarged cross-sectional view of the electronic wind instrument taken along line VIIb-VIIb of FIG. 7A.

FIG. 8 is a partially enlarged cross-sectional view of the electronic wind instrument of the second embodiment.

FIG. 9A is a partially enlarged cross-sectional view of the electronic wind instrument of the third embodiment, and FIG. 9B is a partially enlarged cross-sectional view of the electronic wind instrument of the fourth embodiment.

### DESCRIPTION OF THE EMBODIMENTS

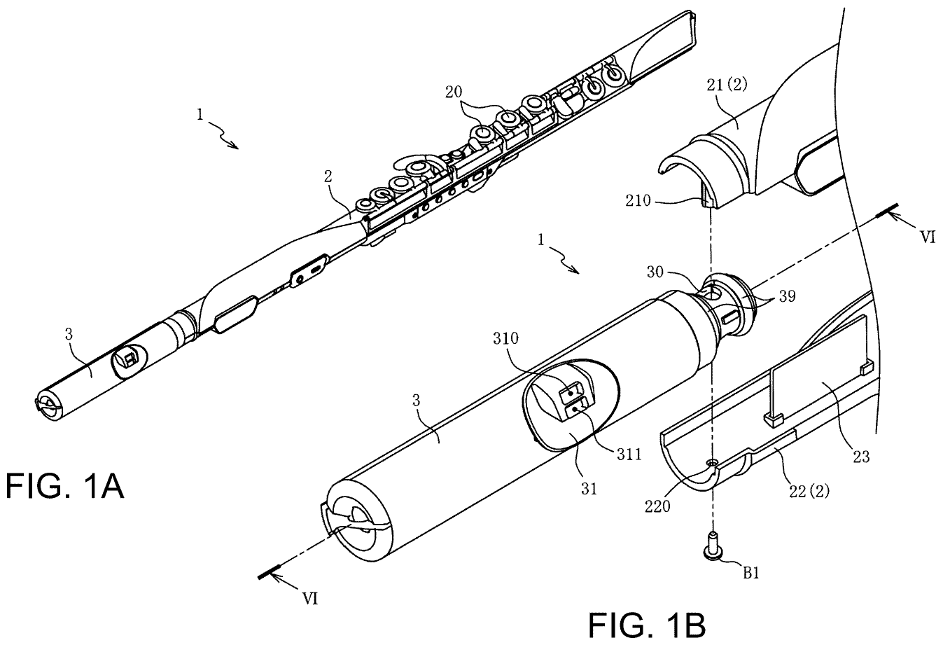

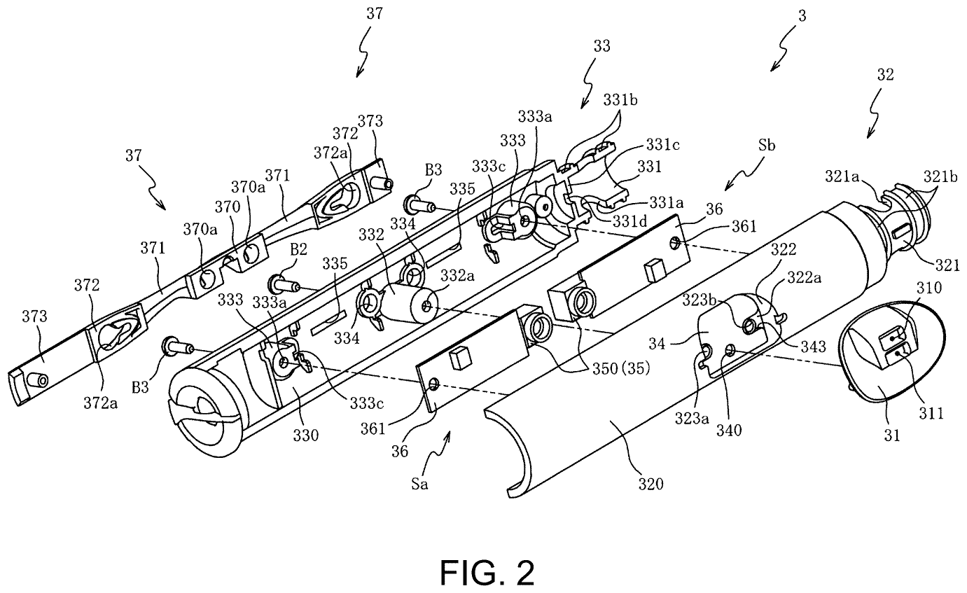

Hereinafter, preferred embodiments will be described with reference to the accompanying drawings. First, with reference to FIG. 1A, FIG. 1B, and FIG. 2, the overall configuration of the electronic wind instrument 1 of the first embodiment will be described. FIG. 1A is a perspective view of the electronic wind instrument 1 of the first embodiment, and FIG. 1B is a partially enlarged perspective view of the electronic wind instrument 1 showing a state in which the instrument body 2 is disassembled. FIG. 2 is an exploded perspective view of the air inlet unit 3. It is noted that FIG. 2 illustrates a state in which O-rings 39 (see FIG. 1A and FIG. 1B) mounted to the air inlet unit 3 is removed. Further, in the following description, a direction orthogonal to the axial direction (longitudinal direction) of the electronic wind instrument 1 is described as the radial direction, and a direction around the axis is described as the circumferential direction.

As shown in FIG. 1A and FIG. 1B, the electronic wind instrument 1 is an electronic musical instrument that imitates an acoustic wind instrument (in this embodiment, a flute). The electronic wind instrument 1 includes an instrument body 2 that imitates a main tube of a flute, and an air inlet unit 3 that imitates a head joint is mounted to an end portion in the axial direction of the instrument body 2.

The instrument body 2 includes a substantially semi-cylindrical upper housing 21 (first housing) and lower housing 22 (second housing), and multiple keys 20 are mounted to an outer circumferential surface of the upper housing 21. A cylindrical protrusion 210 (boss) is integrally formed at an end portion of the upper housing 21 on the air inlet unit 3 side in the axial direction. The protrusion 210 protrudes from an inner circumferential surface of the upper housing 21 toward the lower housing 22, and a penetrating hole 220 for passing a bolt B1 is formed in the lower housing 22 at a position corresponding to a tip end of the protrusion 210.

An insertion hole 30 for inserting the protrusion 210 of the upper housing 21 is formed at an end portion of the air inlet unit 3 on the instrument body 2 side in the axial direction, and a bolt hole (fastening hole) not shown is formed at the tip end of the protrusion 210 of the upper housing 21. The air inlet unit 3 is mounted to the instrument body 2 by screwing a bolt B1 passed through the penetrating hole 220 into the protrusion 210 in a state in which the protrusion 210 of the upper housing 21 is inserted into the insertion hole 30 of the air inlet unit 3.

In a state in which the air inlet unit 3 is mounted to the instrument body 2, a cylindrical end portion (second cylinder portion) of the air inlet unit 3 is rotatably inserted into an inner circumferential side of a cylindrical part (first cylinder portion) formed by stacking the housings 21 and 22 of the instrument body 2. An O-ring 39 (seal material) made of rubber or elastomer is mounted to this insertion part of the air inlet unit 3, and rattling during rotation of the air inlet unit 3 is suppressed by this O-ring 39.

A lip plate 31 is mounted to an outer circumferential surface of the air inlet unit 3, and an upper air inlet 310 (first air inlet) and a lower air inlet 311 (second air inlet) are formed in the lip plate 31 arranged side by side in a circumferential direction. Each of these air inlets 310 and 311 is a rectangular opening formed to be horizontally long in an axial direction of the air inlet unit 3.

Performance of the electronic wind instrument 1 is carried out by the performer switching the blowing direction of exhaled air to each air inlet 310 and 311 (blowing separately) while operating the keys 20. In the case of performing such performance, the orientation of each air inlet 310 and 311 (relative position between the keys 20 and the air inlets 310 and 311) may be adjusted by rotating the air inlet unit 3 relative to the instrument body 2. This enables the positional relationship between the hand position for operating the keys 20 and each air inlet 310 and 311 to be changed according to the performer's preference.

Electronic components such as a substrate 23 are housed in an internal space surrounded by the housings 21 and 22 of the instrument body 2. A CPU is provided on the substrate 23, and musical sounds are generated based on the operation state of the keys 20 and the exhaled air blowing state (blowing amount) to each air inlet 310 and 311 by musical sound generation processing executed by this CPU.

As shown in FIG. 2, the air inlet unit 3 includes a substantially semi-cylindrical air inlet side housing 32 (third housing) and an exhaust side housing 33 (fourth housing). Each of these housings 32 and 33 is a resin component that includes a large diameter portion 320 and 330 having a relatively large diameter, and a small diameter portion 321 and 331 formed on one end side in the axial direction of the large diameter portion 320 and 330 and having a smaller diameter than the large diameter portion 320 and 330.

The large diameter portion 320 and the small diameter portion 321 of the air inlet side housing 32 are integrally formed, and similarly, the exhaust side housing 33 also has the large diameter portion 330 and the small diameter portion 331 integrally formed. Semi-elliptical notches 321a and 331a are formed at two end portions in the circumferential direction of the small diameter portions 321 and 331 of the housings 32 and 33, respectively, and by stacking the housings 32 and 33 together, a pair of the above-mentioned insertion holes 30 (see FIG. 1B) are formed at positions facing each other in a radial direction.

Grooves 321b and 331b extending across two ends in the circumferential direction are formed on outer circumferential surfaces of the small diameter portions 321 and 331 of the housings 32 and 33, respectively. Annular O-rings 39 (see FIG. 1B) are mounted in these grooves 321b and 331b.

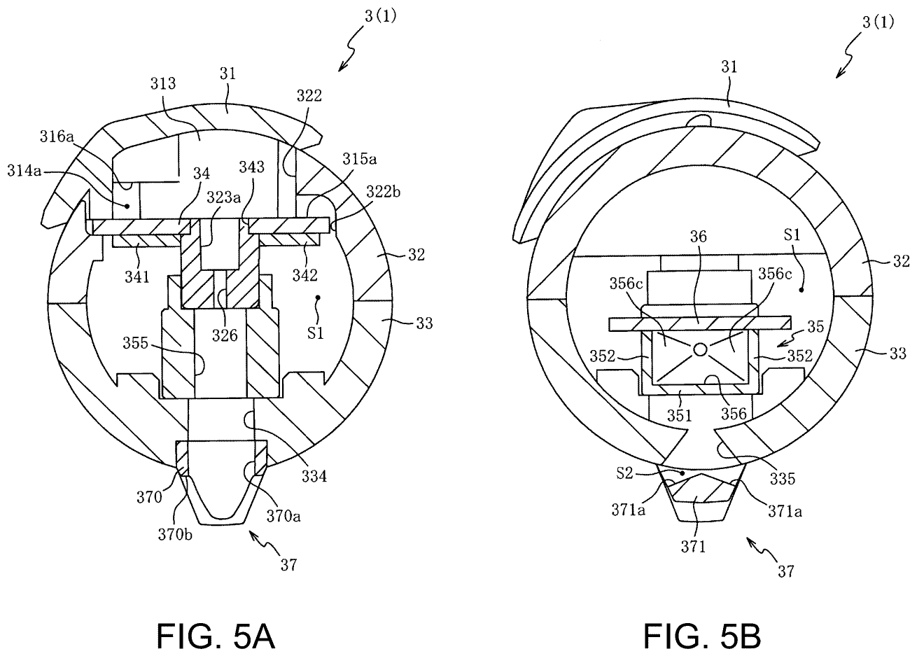

A mounting hole 322 for mounting the lip plate 31 is formed in the large diameter portion 320 of the air inlet side housing 32, and a substrate 34 is sandwiched between a bottom surface 322a of this mounting hole 322 and the lip plate 31. It is noted that an opening portion (hole) connected to an internal space S1 (see FIG. 5A and FIG. 5B) of the air inlet unit 3 is formed in the bottom surface 322a. The substrate 34 is for heating the lip plate 31 to remove moisture, and details of the configuration related to this heating will be described later.

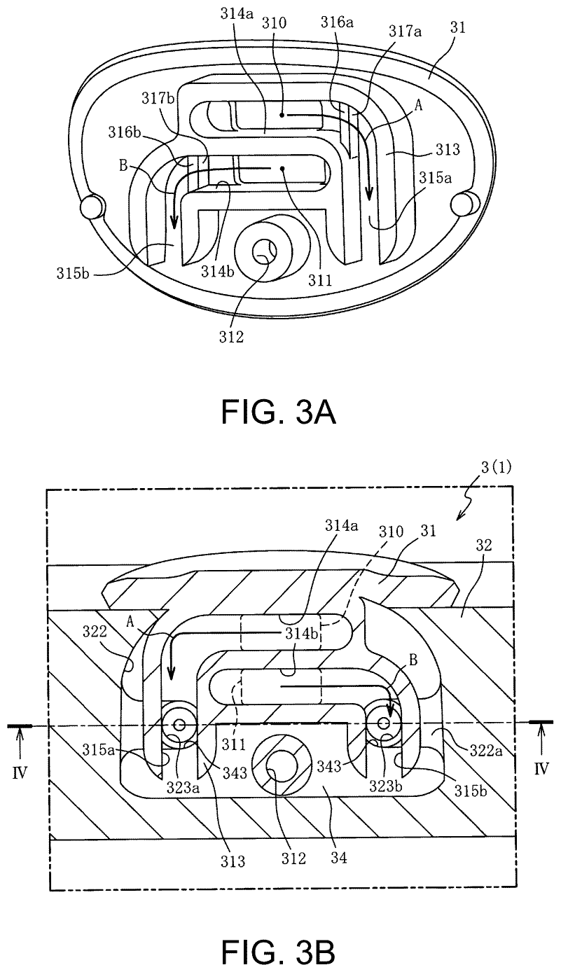

A boss 332 for fixing the lip plate 31 is integrally formed on an inner circumferential surface of the large diameter portion 330 of the exhaust side housing 33. The boss 332 is a cylindrical protrusion that rises from the inner circumferential surface of the large diameter portion 330 toward the air inlet side housing 32 side. An insertion hole 332a for inserting a bolt B2 is formed at the center of the boss 332, and a similar insertion hole 340 is also formed in the substrate 34 (bottom surface 322a of the mounting hole 322). By screwing the bolt B2 inserted into the insertion holes 332a and 340 of the boss 332 and the substrate 34 into a bolt hole 312 (see FIG. 3A and FIG. 3B) of the lip plate 31, the lip plate 31 is fixed to the mounting hole 322 (outer circumferential surface) of the air inlet side housing 32.

Housing side flow paths 323a and 323b for passing exhaled air blown from the air inlets 310 and 311 are formed on the bottom surface 322a of the mounting hole 322. The housing side flow paths 323a and 323b are flow paths extending in a radial direction of the air inlet side housing 32 (blowing direction of exhaled air into the air inlets 310 and 311 by a performer). The housing side flow paths 323a and 323b are formed as a pair spaced apart in an axial direction of the air inlet side housing 32 (air inlet unit 3), and notches 343 (penetrating holes) are formed in the substrate 34 at positions corresponding to the housing side flow paths 323a and 323b. The exhaled air that has passed through this pair of housing side flow paths 323a and 323b is introduced into a pair of sensor modules Sa and Sb.

The pair of sensor modules Sa and Sb are arranged symmetrically with a plane orthogonal to the axial direction of the air inlet unit 3 (a plane including the air inlets 310 and 311) as a plane of symmetry (hereinafter, such symmetry is simply referred to as “symmetrical”). The sensor module Sa detects exhaled air blown into the upper air inlet 310, and the sensor module Sb detects exhaled air blown into the lower air inlet 311. The sensor modules Sa and Sb are identical components, respectively, and include a resin case 35 and a substrate 36 mounted to the case 35 by adhesion or the like.

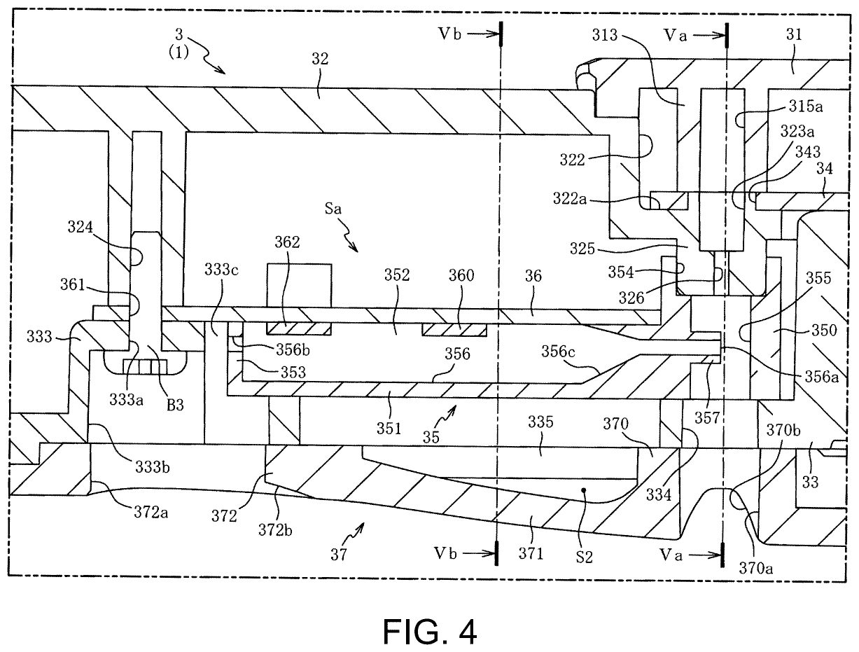

Each case 35 of the sensor modules Sa and Sb is formed with a cylindrical cylinder portion 350 through which exhaled air blown from the air inlets 310 and 311 passes, and the exhaled air that has passed through this cylinder portion 350 is detected by a temperature sensor 360 (see FIG. 4) provided on the substrate 36. Details of this exhaled air detection method will be described later.

Bosses 333 for fixing the pair of sensor modules Sa and Sb are integrally formed on inner circumferential surfaces at two ends side in the axial direction of the exhaust side housing 33. The boss 333 is a cylindrical protrusion that rises toward the air inlet side housing 32 side, and an insertion hole 333a for passing a bolt B3 is formed at the center of the boss 333.

A similar insertion hole 361 is formed at an end portion of the substrate 36 on the opposite side from the cylinder portion 350 in the axial direction, and a bolt hole 324 (see FIG. 4) is formed on an inner circumferential surface of the air inlet side housing 32 at a position corresponding to the boss 333 (insertion hole 333a). By screwing the bolt B3 inserted into the insertion holes 333a and 361 of the boss 333 and the substrate 36 into the bolt hole 324 of the air inlet side housing 32, the sensor modules Sa and Sb are fixed inside the air inlet unit 3.

In this fixed state, the cylinder portion 350 of the sensor modules Sa and Sb and the first exhaust port 334 of the exhaust side housing 33 communicate with each other. The first exhaust ports 334 are provided in a pair with an interval in the axial direction (with the boss 332 interposed therebetween), and exhaled air blown into the air inlets 310 and 311 is discharged mainly from these first exhaust ports 334. A pair of second exhaust ports 335 are formed on two sides in the axial direction of the pair of first exhaust ports 334. Each of these exhaust ports 334 and 335 is a hole that penetrates the large diameter portion 330 of the exhaust side housing 33, the first exhaust port 334 is formed in a circular shape, and the second exhaust port 335 is formed in a rectangular shape that is long in the axial direction.

Each exhaust port 334 and 335 is covered by a decorative body 37 (covering member) that extends in the axial direction. The decorative body 37 includes a first covering portion 370 that covers the first exhaust port 334, and a penetrating hole 370a is formed in the first covering portion 370 at a position corresponding to the first exhaust port 334. A pair of second covering portions 371 that cover the pair of second exhaust ports 335 are provided on two sides in the axial direction of the first covering portion 370, and a pair of third covering portions 372 are provided on two sides in the axial direction of the pair of second covering portions 371.

The third covering portion 372 is a portion that covers a recess portion 333b (see FIG. 4) formed on the outer circumferential surface of the exhaust side housing 33 by the boss 333, and a penetrating hole 372a is formed in the third covering portion 372 at a position corresponding to the recess portion 333b. A pair of fixed portions 373 are provided on two sides in the axial direction of the pair of third covering portions 372, and the pair of fixed portions 373 are fixed to the outer circumferential surface of the exhaust side housing 33 (large diameter portion 330) by bolts (not shown).

Each portion 370 to 373 constituting the decorative body 37 is integrally formed using a resin material. By covering each exhaust port 334 and 335 and recess portion 333b (see FIG. 4) with each portion 370 to 373 of the decorative body 37, the appearance of the electronic wind instrument 1 may be improved.

Next, with reference to FIG. 2 and FIG. 3A and FIG. 3B, the flow path of exhaled air from each air inlet 310 and 311 to the pair of housing side flow paths 323a and 323b will be described. FIG. 3A is a perspective view of the lip plate 31 viewed from the inside, and FIG. 3B is a partially enlarged cross-sectional view of the air inlet unit 3 (electronic wind instrument 1). FIG. 3B shows a cross-section taken along a plane that is orthogonal to the blowing direction of exhaled air into the air inlets 310 and 311 by the performer (radial direction of the air inlet side housing 32) and includes the barrier wall 313 of the lip plate 31.

It is noted that FIG. 3B is a cross-sectional view that does not include each air inlet 310 and 311 or restricted walls 317a and 317b (see FIG. 3A), but in FIG. 3B, the positions where the air inlets 310 and 311 are formed are shown by broken lines. Further, in the following description, the side of each air inlet 310 and 311 is referred to as an upstream side of the exhaled air flow path, and the opposite side is referred to as the downstream side.

As shown in FIG. 2, FIG. 3A, and FIG. 3B, a barrier wall 313 that partitions the flow path of exhaled air is integrally formed on the inner surface of the lip plate 31. The barrier wall 313 is formed in a wall shape that rises from the inner surface of the lip plate 31, and the tip end of this barrier wall 313 (the end portion on the back side in the perpendicular direction to the paper surface of FIG. 3B) is configured to contact the substrate 34. The first bent flow paths 314a and 314b and the second bent flow paths 315a and 315b are formed by the space surrounded by this barrier wall 313 and the substrate 34.

The first bent flow path 314a is a flow path that extends linearly from the upper air inlet 310 to one side in the axial direction of the air inlet side housing 32 (left side in FIG. 3B). From the downstream end portion(left side in FIG. 3B) of the first bent flow path 314a, the second bent flow path 315a bends perpendicularly (in the circumferential direction of the air inlet side housing 32), and the portion at the downstream side of this second bent flow path 315a is connected to the housing side flow path 323a through the notch 343 of the substrate 34.

The first bent flow path 314b is a flow path that extends linearly from the lower air inlet 311 to the other side in the axial direction of the air inlet side housing 32 (right side in FIG. 3B). From the end portion at the downstream side (right side in FIG. 3B) of the first bent flow path 314b, the second bent flow path 315b bends perpendicularly (in the circumferential direction of the air inlet side housing 32 and in the same direction as the second bent flow path 315a), and the portion at the downstream side of this second bent flow path 315b is connected to the housing side flow path 323b through the notch 343 of the substrate 34.

Further, a restricted flow path 316a (see FIG. 3A) is formed at the boundary part between the first bent flow path 314a and the second bent flow path 315a, and a restricted flow path 316b is also formed at the boundary part between the first bent flow path 314b and the second bent flow path 315b. These restricted flow paths 316a and 316b are formed by restricted walls 317a and 317b that connect the walls of the barrier wall 313.

The restricted walls 317a and 317b are walls that extend to cross each bent flow path 314a, 314b, 315a, and 315b, and the erected height of the restricted walls 317a and 317b from the inner surface of the lip plate 31 is formed lower than the erected height of the barrier wall 313. By forming these restricted walls 317a and 317b, restricted flow paths 316a and 316b having a smaller flow path cross-sectional area than each bent flow path 314a, 314b, 315a, and 315b are formed.

As shown by arrow A in FIG. 3A and FIG. 3B, the exhaled air blown from the upper air inlet 310 is introduced into the housing side flow path 323a through the first bent flow path 314a, the restricted flow path 316a, and the second bent flow path 315a (notch 343 of the substrate 34). On the other hand, as shown by arrow B, the exhaled air blown from the lower air inlet 311 is introduced into the housing side flow path 323b through the first bent flow path 314b, the restricted flow path 316b, and the second bent flow path 315b (notch 343 of the substrate 34).

Next, with reference to FIG. 3A, FIG. 3B, and FIG. 4, the exhaled air flow path from the housing side flow paths 323a and 323b to the first exhaust port 334 will be described. FIG. 4 is a partially enlarged cross-sectional view of the air inlet unit 3 taken along line IV-IV in FIG. 3A and FIG. 3B. It is noted that the flow paths downstream of the housing side flow paths 323a and 323b are formed symmetrically between the sensor module Sa side and the sensor module Sb side. Thus, in the following description, the exhaled air flow path on the sensor module Sa side (see FIG. 4) will be described, and the description of the flow path on the sensor module Sb side will be omitted.

As shown in FIG. 3A and FIG. 3B and FIG. 4, a cylindrical lower protrusion 325 (see FIG. 4) is integrally formed on an inner circumferential surface on the opposite side from the bottom surface 322a of the mounting hole 322 of the air inlet side housing 32. A restricted flow path 326 connected to the housing side flow path 323a is formed on the inner circumferential side of the lower protrusion 325, and the case 35 of the sensor modules Sa and Sb is mounted to the lower protrusion 325.

The case 35 includes the above-described cylinder portion 350, a bottom wall portion 351 extending from the cylinder portion 350 to one side in the axial direction (left side in FIG. 4) of the air inlet unit 3, and a side wall portion 352 and an end wall portion 353 rising from the bottom wall portion 351, and these portions 350 to 353 are integrally formed. On the inner circumferential side of the cylinder portion 350, a fitting hole 354 into which the lower protrusion 325 is fitted and a case side flow path 355 connected to the fitting hole 354 are formed.

The fitting hole 354 and the case side flow path 355 are each formed with a circular cross-section. By forming the inner diameter of the case side flow path 355 smaller than the inner diameter of the fitting hole 354, a step is formed on the inner circumferential side of the cylinder portion 350, and the lower protrusion 325 is fitted into this step portion.

In the state where the cylinder portion 350 is mounted to the lower protrusion 325, the housing side flow path 323a, the restricted flow path 326, and the case side flow path 355 form a flow path that extends linearly in the radial direction (substantially parallel to the blowing direction of exhaled air into each air inlet 310 and 311).

The exhaled air blown into the upper air inlet 310 (see FIG. 3A and FIG. 3B) is exhausted from the first exhaust port 334 through the above-described bent flow paths 314a and 315a (for the first bent flow path 314a, see FIG. 3A and FIG. 3B), the housing side flow path 323a, the restricted flow path 326, and the case side flow path 355. Hereinafter, these flow paths 314a, 315a, 323a, 326, and 355 will be collectively referred to and described as the “main flow path” of exhaled air.

The bottom wall portion 351 of the case 35 is formed in a flat plate shape extending in the axial direction of the air inlet unit 3, and the side wall portions 352 are formed in a pair on two end sides in the width direction of the bottom wall portion 351 (perpendicular direction to the paper surface in FIG. 4) (see FIG. 5B). The end wall portion 353 is formed in a wall shape rising from the end portion in the axial direction of the bottom wall portion 351 (the end portion on the opposite side from the cylinder portion 350 side), and these wall portions 351 to 353 are formed in a box shape with one surface side (air inlet side housing 32 side) open. By closing this open part with the substrate 36, a branch flow path 356 surrounded by the substrate 36 and the wall portions 351 to 353 is formed inside the case 35.

The branch flow path 356 is a flow path extending in the axial direction of the air inlet unit 3, and in order to connect one end portion thereof to the main flow path (case side flow path 355), an opening 356a (first opening) of the branch flow path 356 is formed on an inner circumferential surface of the case side flow path 355. That is, the branch flow path 356 branches so as to intersect with the case side flow path 355. Further, the other end portion of the branch flow path 356 is connected to the outside of the case 35 through an opening 356b (second opening) formed in the end wall portion 353.

On the inner surface of the substrate 36 facing the branch flow path 356, a temperature sensor 360 and a heater 362 are provided arranged in the axial direction (longitudinal direction of the branch flow path 356). The temperature sensor 360 may use a known temperature sensor composed of a thermistor or the like, and the heater 362 may use a known heating element such as a chip resistor, so detailed description is omitted.

The air in the branch flow path 356 is heated by the heater 362, and the flow of the heated air (temperature change in the branch flow path 356) is detected by the temperature sensor 360. In the case of the case side flow path 355 side being an upstream side of the branch flow path 356, in this embodiment the temperature sensor 360 is disposed on an upstream side of the heater 362, but the temperature sensor 360 may be disposed on the downstream side of the heater 362. Further, the temperature sensor 360 and the heater 362 may be arranged side by side in the width direction (perpendicular direction to the paper surface in FIG. 4) orthogonal to the longitudinal direction of the branch flow path 356 (left-right direction in FIG. 4).

In the case of the flow rate (flow velocity) of exhaled air flowing in the main flow path (case side flow path 355) changing, changes also occur in the airflow generated in the branch flow path 356 (sub flow path branching from the main flow path), and changes in the airflow in this branch flow path 356 (temperature changes due to the flow of air heated by the heater 362) are detected by the temperature sensor 360. A musical sound signal based on the detection result of this temperature sensor 360 is generated by a sound source, and electronic sound based on the musical sound signal is emitted from an amplifier, speaker (both not shown), or the like.

In order to accurately detect the flow rate of exhaled air flowing in the main flow path with the temperature sensor 360 based on such changes in airflow in the branch flow path 356, it is necessary to prevent saliva contained in the exhaled air and moisture generated by condensation of humidity contained in the exhaled air from remaining in the main flow path or the branch flow path 356. In particular, in a state where such moisture adheres to the temperature sensor 360, it becomes difficult to accurately detect the performer's exhaled air. A configuration that resolves these problems is described below.

The case side flow path 355 and the opening 356a of the branch flow path 356 are each formed with a circular cross-section, but the diameter of the opening 356a of the branch flow path 356 is formed smaller compared to the diameter of the case side flow path 355. That is, the cross-sectional area of the opening 356a of the branch flow path 356 is formed smaller compared to the cross-sectional area of the part (case side flow path 355) of the main flow path to which the opening 356a of the branch flow path 356 is connected. This provides an effect of making it difficult for exhaled air containing humidity to flow into the temperature sensor 360 side disposed in the branch flow path 356.

This may be attributed to the fact that since the opening 356a of the branch flow path 356 is formed relatively small, exhaled air passing through the case side flow path 355 becomes difficult to flow into the branch flow path 356 side. Further, as another factor, it is conceivable that negative pressure is generated in the branch flow path 356 by the exhaled air passing through the case side flow path 355, and the air in the branch flow path 356 is drawn from the opening 356a into the case side flow path 355 by that negative pressure.

By suppressing exhaled air containing humidity from flowing into the branch flow path 356 side, it is possible to suppress moisture generated by condensation or the like from adhering to the temperature sensor 360. Thus, the flow rate (flow velocity) of exhaled air flowing in the main flow path may be accurately detected by the temperature sensor 360 based on changes in airflow generated in the branch flow path 356.

Further, a cylindrical protrusion portion 357 whose tip end becomes the opening 356a of the branch flow path 356 is integrally formed on the inner circumferential surface of the case side flow path 355. By causing the opening 356a of the branch flow path 356 to protrude toward the inner circumferential side of the case side flow path 355 with this protrusion portion 357, it is considered that effects are obtained such that exhaled air containing humidity becomes difficult to flow into the branch flow path 356 side, and negative pressure becomes more likely to be generated in the branch flow path 356 by exhaled air passing through the main flow path.

Further, the tip end of the protrusion portion 357 (the edge of the opening 356a of the branch flow path 356) is disposed on an extension line of the flow path of the restricted flow path 326. That is, in a view of the inflow direction of exhaled air from the restricted flow path 326 to the case side flow path 355 (up-down direction view in FIG. 4), the restricted flow path 326 and the tip end of the protrusion portion 357 are disposed at overlapping positions. This is also considered to provide an effect that negative pressure becomes more likely to be generated in the branch flow path 356 by exhaled air passing through the main flow path.

Thus, this embodiment has a structure in which exhaled air flowing into the branch flow path 356 from the opening 356a having a relatively small cross-sectional area is detected by the temperature sensor 360, or a structure in which negative pressure is generated in the branch flow path 356 by exhaled air passing through the case side flow path 355, and the airflow in the branch flow path 356 generated by that negative pressure is detected by the temperature sensor 360. In the case of such a structure, changes in airflow generated in the branch flow path 356 become relatively small. Here, with a configuration that detects temperature changes of air in the branch flow path 356 heated by the heater 362 with the temperature sensor 360 as in this embodiment, slight changes in airflow generated in the branch flow path 356 may be detected by the temperature sensor 360. Thus, the flow rate of exhaled air flowing in the main flow path may be detected with high accuracy.

Further, since the sensor modules Sa and Sb are arranged in the axial direction with the cylinder portions 350 facing each other (see FIG. 2), and the branch flow path 356 is formed along the axial direction (longitudinal direction) of the air inlet unit 3, the branch flow path 356 for sensing exhaled air may be formed long. This enables each cylinder portion 350 to be positioned close to the lip plate 31 and the air inlet unit 3 to simulate the appearance of an elongated flute (head joint), while allowing changes in airflow within the branch flow path 356 to be accurately detected by the temperature sensor 360.

Further, in this embodiment, exhaled air blown into the upper air inlet 310 and exhaled air blown into the lower air inlet 311 are detected by separate sensor modules Sa and Sb (see FIG. 2). That is, instead of forming two branch flow paths 356 in one case 35, the configuration uses two cases 35 as separate components (making the cases 35 compact) to individually form branch flow paths 356, so the shape of the branch flow paths 356 may be formed with high accuracy. Thus, airflow generated in the branch flow paths 356 may be accurately detected by the temperature sensors 360.

Thus, in this embodiment, exhaled air is detected based on airflow generated in the branch flow path 356, and a tapered surface 356c for stabilizing this airflow is formed in the branch flow path 356. The tapered surface 356c is an inclined surface connected to one end (the end portion on the opening 356a side) of the inner surface of the bottom wall portion 351 or side wall portion 352 of the case 35 (regarding the point where the tapered surface 356c is connected to the side wall portion 352, see FIG. 5B). By forming such a tapered surface 356c, the cross-sectional area of the branch flow path 356 may be gradually reduced toward the opening 356a side. This may suppress the occurrence of irregular airflow (turbulent flow) within the branch flow path 356, so the flow rate of exhaled air flowing in the main flow path may be accurately detected by the temperature sensor 360.

Further, a ventilation opening 333c is formed on the side surface of the boss 333 that faces the end wall portion 353 of the case 35, and the recess portion 333b formed on the outer circumferential surface of the exhaust side housing 33 by the boss 333 is connected to the opening 356b of the branch flow path 356 via the ventilation opening 333c. This enables ventilation of the interior of the branch flow path 356 by airflow passing through the ventilation opening 333c and the opening 356b, so condensation on the temperature sensor 360 may be suppressed.

Further, by utilizing the boss 333 (recess portion 333b) for fixing the sensor modules Sa and Sb to ventilate the branch flow path 356, it becomes unnecessary to separately provide holes or indentations in the exhaust side housing 33 for performing such ventilation. Thus, the number of holes and indentations formed in the exhaust side housing 33 may be reduced, so the appearance of the electronic wind instrument 1 may be improved.

Here, for example, in the case of a performer taking a breath during performance, air may be drawn in from the upper air inlet 310 (see FIG. 3A and FIG. 3B). Further, for example, in the case of a performer performing an action with their mouth separated from the upper air inlet 310, outside air may flow in from the upper air inlet 310 due to the accompanying movement of the electronic wind instrument 1. In response to the temperature sensor 360 detecting airflow accompanying such intake air or inflow of outside air, a problem arises where musical sounds unintended by the performer are generated.

Further, in the case of a performer strongly blowing exhaled air into the upper air inlet 310, the flow rate of that exhaled air may exceed the measurable range of the temperature sensor 360. Outside such measurement range of the temperature sensor 360, even if the flow rate of exhaled air is changed, no change occurs in the generated musical sound, so a problem arises where musical sounds intended by the performer become difficult to generate.

In contrast, in this embodiment, as described above, the lip plate 31 is formed with the first bent flow path 314a (see FIG. 3A and FIG. 3B) that extends in a direction orthogonal to the blowing direction of exhaled air into the upper air inlet 310 (in this embodiment, in the axial direction of the air inlet unit 3). Furthermore, the second bent flow path 315a connected to the downstream side of the first bent flow path 314a extends in a direction that further bends from the connection portion (in this embodiment, a direction orthogonal to both the blowing direction of exhaled air and the axial direction of the air inlet unit 3).

By forming such bent flow paths on an upstream side of the main flow path, compared to a case where the upper air inlet 310 and the housing side flow path 323a are connected in a straight line, for example, even if the above-mentioned intake air by the performer or inflow of outside air occurs, generation of accompanying airflow in the case side flow path 355 may be suppressed.

Further, at the boundary parts of these bent flow paths 314a and 315a, a restricted flow path 316a (see FIG. 3A) having a smaller flow path cross-sectional area than each of the bent flow paths 314a and 315a is formed. Furthermore, a restricted flow path 326 having a smaller flow path cross-sectional area than each of those flow paths 323a and 355 is also formed between the housing side flow path 323a and the case side flow path 355. By providing such restricted parts where the cross-sectional area of the main flow path is partially reduced in the middle of the main flow path (an upstream side of the connection portion of the branch flow path 356), generation of airflow accompanying the above-mentioned intake air by the performer or inflow of outside air in the case side flow path 355 may also be suppressed.

By suppressing generation of airflow accompanying intake air by the performer or inflow of outside air in the case side flow path 355, erroneous detection of that airflow by the temperature sensor 360 may be suppressed. Thus, generation of musical sounds unintended by the performer may be suppressed.

Further, by adjusting the flow path length of each bent flow path 314a and 315a, or by adjusting the flow path cross-sectional area of the restricted flow paths 316a and 326, it is possible to suppress exhaled air that the performer strongly blows into the upper air inlet 310 from exceeding the measurable range of the temperature sensor 360. Thus, musical sounds intended by the performer become easier to generate.

In this way, by providing bent parts and restricted parts in the main flow path, musical sounds intended by the performer become easier to generate. However, if the path of the main flow path is formed in a complex manner, saliva contained in exhaled air and moisture generated by condensation tend to remain in the main flow path. If this moisture blocks, for example, the restricted flow path 326 or the opening 356a of the branch flow path 356, it becomes difficult to detect exhaled air blown from each air inlet 310 and 311 with the temperature sensor 360.

Thus, in this embodiment, a configuration is adopted in which moisture is dried by heating the part on the upstream side of the main flow path with the substrate 34. Furthermore, this configuration also provides an effect of preventing condensation from occurring in the main flow path. This effect of preventing condensation refers to preventing water vapor contained in air from liquefying, which is a different action from drying moisture. That is, since the saturated water vapor amount (mass of water vapor that may exist in a unit volume of air) increases as temperature becomes higher, by heating the portion on the upstream side of the main flow path, not only may moisture be dried, but condensation may also be prevented from occurring. This configuration will be described with reference to FIG. 4, FIG. 5A, and FIG. 5B.

FIG. 5A is a cross-sectional view of the air inlet unit 3 taken along line Va-Va in FIG. 4, and FIG. 5B is a cross-sectional view of the air inlet unit 3 taken along line Vb-Vb in FIG. 4.

As shown in FIG. 4, FIG. 5A, and FIG. 5B, the substrate 34 is provided with a heater 341 and a temperature sensor 342 (both refer to FIG. 5A). In the following description, the surface of the substrate 34 that faces toward each bent flow path 314a and 315a side (upper side in FIG. 4, FIG. 5A, and FIG. 5B) is described as the front surface of the substrate 34, and the surface on the opposite side is described as the back surface of the substrate 34.

The substrate 34 is a single-sided substrate on which electronic components such as the heater 341 and the temperature sensor 342, and a temperature control device (CPU) that controls the temperature of these components are mounted on the back surface. An opening (hole) connected to the internal space S1 of the air inlet unit 3 is formed in the bottom surface 322a of the mounting hole 322 where the substrate 34 and lip plate 31 are mounted, and the heater 341 and the temperature sensor 342 are mounted on the back surface of the substrate 34 exposed from this opening.

The heater 341 may use a known heating element such as a chip resistor, and the temperature sensor 342 may use a known temperature sensor composed of a thermistor or the like, so detailed description is omitted.

The temperature of the substrate 34 accompanying heating by the heater 341 is detected by the temperature sensor 342, and temperature control is performed so that the heater 341 repeats on/off (or the temperature of the heater 341 changes) based on the detection result of the temperature sensor 342.

By heating the substrate 34 (mounting wall where the heater 341 is mounted) that forms a portion (bottom surface) of the inner wall surface of each bent flow path 314a and 315a with the heater 341, the entire inner wall surface of each bent flow path 314a and 315a and the internal space of each bent flow path 314a and 315a are heated, so saliva adhering to each bent flow path 314a and 315a may be dried and moisture due to condensation in each bent flow path 314a and 315a may be suppressed from occurring. This may suppress moisture from remaining in each bent flow path 314a and 315a, so the flow of exhaled air may be suppressed from being blocked by the moisture, and the moisture may be suppressed from flowing down to the downstream side (temperature sensor 360 side). Thus, the flow of exhaled air blown into the air inlets 310 and 311 (refer to FIG. 3A and FIG. 3B) may be accurately detected by the temperature sensor 360.

The heater 341 may be mounted, for example, on the front surface of the substrate 34 (bottom surface of each bent flow path 314a and 315a), but in this embodiment, since the heater 341 is mounted on the back surface of the substrate 34, the flow of exhaled air in each bent flow path 314a and 315a may be suppressed from being obstructed by the heater 341. Thus, exhaled air flows easily from each bent flow path 314a and 315a toward the downstream side, so the exhaled air may be accurately detected by the temperature sensor 360.

Since each bent flow path 314a and 315a is formed by the substrate 34 (mounting wall) and the barrier wall 313 of the lip plate 31 that abuts against the front surface of the substrate 34, bent flow paths such as each bent flow path 314a and 315a may be easily formed. On the other hand, in the configuration where the barrier wall 313 abuts against the substrate 34, there is a risk that heat may escape from the gap between the substrate 34 and the barrier wall 313.

In contrast, in this embodiment, since the abutting part of the barrier wall 313 against the substrate 34 is joined by adhesive, sealant, or the like, air heated by the heater 341 (substrate 34) may be suppressed from escaping from the gap between the substrate 34 and the barrier wall 313. Thus, the interior of each bent flow path 314a and 315a may be efficiently heated by the heater 341, so moisture may be suppressed from accumulating in each bent flow path 314a and 315a.

Further, since the barrier wall 313 formed on the inner surface of the lip plate 31 abuts against the substrate 34, and this substrate 34 is heated by the heater 341, the upstream part of the main flow path connected to the air inlets 310 and 311 of the lip plate 31 (e.g., the first bent flow path 314a positioned directly below the air inlet 310) may be efficiently heated. This may suppress moisture from accumulating in the upstream part of the main flow path, so the moisture may be suppressed from flowing down to the downstream side of the main flow path.

Further, since the bottom surface of each bent flow path 314a and 315a that bends with respect to the blowing direction of exhaled air into the air inlets 310 and 311 is formed by the substrate 34, and this substrate 34 is heated by the heater 341, the inner wall surface of each bent flow path 314a and 315a where moisture tends to remain may be efficiently heated by the heater 341. Thus, moisture may be suppressed from accumulating in each bent flow path 314a and 315a.

Further, at the boundary part of each bent flow path 314a and 315a (in the middle of the bent flow path), a restricted flow path 316a (see FIG. 5A) having a smaller flow path cross-sectional area than each bent flow path 314a and 315a is formed, and the inner wall surface of this restricted flow path 316a is also formed by the substrate 34 to which the heater 341 is mounted. This enables the inner wall surface of the restricted flow path 316a where moisture tends to remain to be efficiently heated by the heater 341, so moisture may be suppressed from accumulating in the restricted flow path 316a.

As described above, the notch 343 is formed in the substrate 34, and the second bent flow path 315a and the housing side flow path 323a are connected to each other through this notch 343, so the boundary part of the second bent flow path 315a and the housing side flow path 323a (the end portion on an upstream side of the housing side flow path 323a) is surrounded by the substrate 34 (notch 343).

By heating this substrate 34 with the heater 341, the housing side flow path 323a connected to the second bent flow path 315a and the restricted flow path 326 positioned on the downstream side of the housing side flow path 323a may also be heated. Thus, saliva adhering to the housing side flow path 323a and the restricted flow path 326 may be dried, and moisture due to condensation may be suppressed from occurring in the housing side flow path 323a and the restricted flow path 326.

In this way, by suppressing moisture from remaining in the restricted flow path 326 where the cross-sectional area of the flow path is partially reduced and in the main flow path on an upstream side of the opening 356a of the branch flow path 356 (see FIG. 4) (on the upstream side of the temperature sensor 360), the moisture may be suppressed from flowing down to the downstream side of the main flow path together with exhaled air. This may suppress the restricted flow path 326 and the opening 356a of the branch flow path 356 from being blocked by moisture, so exhaled air flowing in the main flow path may be accurately detected by the temperature sensor 360 (see FIG. 4).

The temperature of the heater 341 is controlled by a temperature control device (not shown) provided on the substrate 34, and by this temperature control, the temperature of the front surface of the substrate 34 (the inner wall surfaces of each bent flow path 314a and 315a) is maintained at 30° C. or higher and 45° C. or lower, which includes the range of human body temperature and exhaled air temperature. This enables the substrate 34 to be heated to a degree sufficient to dry moisture in each bent flow path 314a and 315a, the restricted flow path 316a, the housing side flow path 323a, and the restricted flow path 326, while suppressing excessive heating of the substrate 34. By suppressing excessive heating of the substrate 34, deterioration of components around the substrate 34 (e.g., resin components such as the lip plate 31 and the air inlet side housing 32) may be suppressed.

Here, in this embodiment, exhaled air flowing in the main flow path is mainly exhausted from the first exhaust port 334, but a portion of the exhaled air is configured to be introduced into the internal space S1 of each housing 32 and 33 through the leak flow path 322b (see FIG. 5A).

More specifically, the housing side flow path 323a opens in the middle of the second bent flow path 315a, and in the mounting hole 322 where the lip plate 31 is mounted, a leak flow path 322b (see FIG. 5A) is formed that connects the end portion on the downstream side of the second bent flow path 315a to the internal space S1 side of each housing 32 and 33. This leak flow path 322b is formed by a gap between the edge of the substrate 34 in the circumferential direction of the air inlet side housing 32 and the inner circumferential surface of the air inlet side housing 32.

By forming such a leak flow path 322b that branches from the main flow path, a portion of the airflow generated in the second bent flow path 315a may be introduced to the internal space S1 side of the air inlet unit 3 (i.e., a portion of the airflow may be discharged to the outside of the main flow path). This may suppress the generation of airflow in the case side flow path 355 due to the performer's inhalation or inflow of outside air as described above, so erroneous detection of such airflow by the temperature sensor 360 (see FIG. 4) may be suppressed. Thus, generation of musical sounds unintended by the performer may be suppressed.

Further, by adjusting the flow path cross-sectional area of the leak flow path 322b, it is possible to suppress exhaled air that the performer strongly blows into the upper air inlet 310 from exceeding the measurable range of the temperature sensor 360. Thus, musical sounds intended by the performer become easier to generate.

Exhaled air that flows into the internal space S1 side of each housing 32 and 33 from the leak flow path 322b is exhausted from the second exhaust port 335 (see FIG. 5B) that penetrates the exhaust side housing 33. The second covering portion 371 of the decorative body 37 that covers the second exhaust port 335 is formed to be bridged between the first covering portion 370 and the third covering portion 372 (to extend in the axial direction) (see FIG. 4), and a cavity S2 (see FIG. 5B) is formed between the exhaust side housing 33 (second exhaust port 335) and the second covering portion 371.

This may suppress the second exhaust port 335 from being blocked by the placement surface even in the case of the electronic wind instrument 1 being placed on a table or the like, and ventilation through the cavity S2 and the second exhaust port 335 may be ensured. Thus, even with a structure that leaks a portion of exhaled air to the internal space S1 of each housing 32 and 33 through the leak flow path 322b (see FIG. 5A), condensation on components of each housing 32 and 33 (e.g., the substrate 36 shown in FIG. 5B) may be suppressed.

Further, on an inner circumferential surface of the second covering portion 371 that faces the second exhaust port 335, a pair of inclined surfaces 371a (see FIG. 5B) arranged in the circumferential direction are formed. The pair of inclined surfaces 371a are flat surfaces that incline away from the exhaust side housing 33 (second exhaust port 335) from the apex at the center side in the circumferential direction (ridge line where they intersect each other) toward the end portions on the outer side in the circumferential direction. By forming such mountain-shaped inclined surfaces 371a, the flow velocity of air passing through the cavity S2 along the circumferential direction (left-right direction in FIG. 5B) rises due to the inclined surfaces 371a. This rise in the flow velocity of air generates negative pressure in the internal space S1 of each housing 32 and 33, and the negative pressure may exhaust air in the internal space S1 from the second exhaust port 335 to the outside.

Further, since the opening dimension of the second exhaust port 335 in the circumferential direction gradually increases from the internal space S1 toward the outer circumferential surface of the exhaust side housing 33, air in the internal space S1 is easily exhausted from the second exhaust port 335 to the outside by the airflow passing through the cavity S2 as described above. This may suppress condensation on components of each housing 32 and 33 even with a structure that leaks a portion of exhaled air to the internal space S1 of each housing 32 and 33 through the leak flow path 322b (see FIG. 5A).

Further, as described above, penetrating holes 370a and 372a (for the through hole 372a, see FIG. 4) are formed in each covering portion 370 and 372 of the decorative body 37 that covers the first exhaust port 334 and the recess portion 333b (ventilation opening 333c) of the boss 333 (see FIG. 4). For example, a depression 370b is formed at the edges on two sides in the circumferential direction of the penetrating hole 370a. Further, a similar depression 372b is formed at the edges of the penetrating hole 372a shown in FIG. 4.

By forming such depressions 370b and 372b in the penetrating holes 370a and 372a, the first exhaust port 334 and the recess portion 333b (ventilation opening 333c) may be suppressed from being blocked by the placement surface even in the case of the electronic wind instrument 1 being placed on a table or the like. Thus, ventilation through the first exhaust port 334 and the recess portion 333b (ventilation opening 333c) may be ensured.

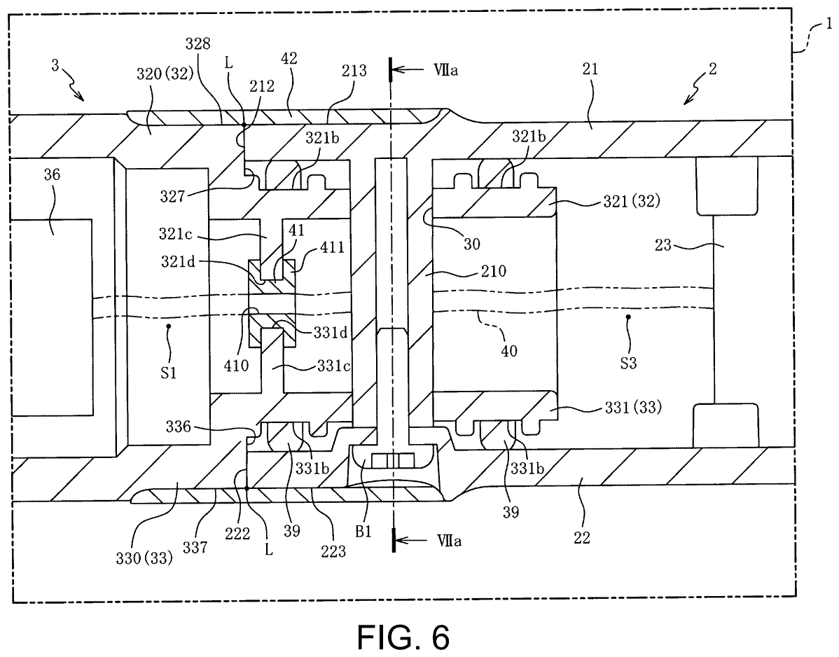

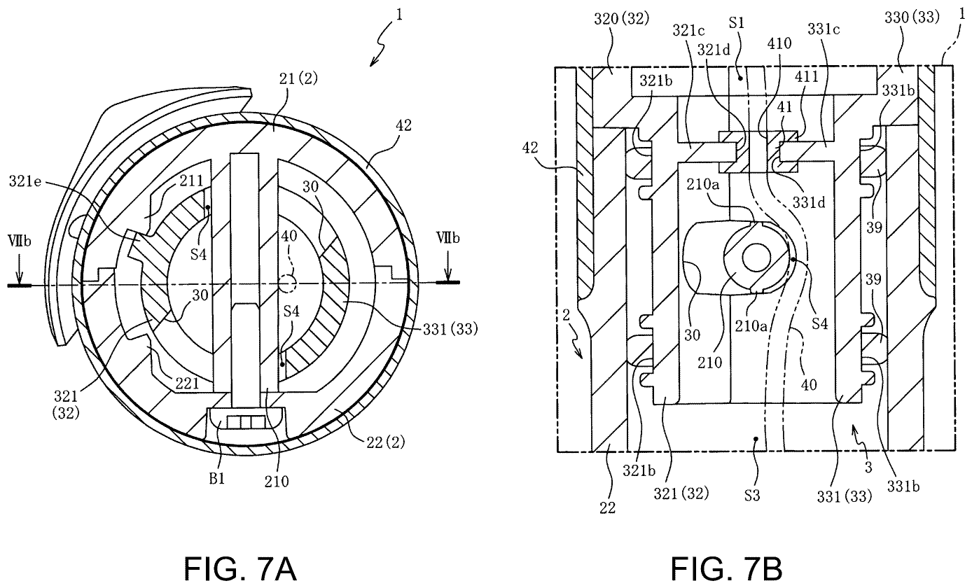

Next, details of the rotation structure of the air inlet unit 3 will be described with reference to FIG. 6, FIG. 7A, and FIG. 7B. FIG. 6 is a partially enlarged cross-sectional view of the electronic wind instrument 1 taken along line VI-VI in FIG. 1A and FIG. 1B. FIG. 7A is a cross-sectional view of the electronic wind instrument 1 taken along line VIIa-VIIa in FIG. 6, and FIG. 7B is a partially enlarged cross-sectional view of the electronic wind instrument 1 taken along line VIIb-VIIb in FIG. 7A. It is noted that FIG. 6 illustrates a cross-section cut along a plane including two axes of the electronic wind instrument 1 and the protrusion 210 in a state where the positional relationship between the instrument body 2 and the air inlet unit 3 is as shown in FIG. 7A. Further, FIG. 6, FIG. 7A, and FIG. 7B illustrate only the main portions of the cross-section of the electronic wind instrument 1, and schematically illustrate the outer shape of multiple wiring 40 bundled together with a two-dot chain line.

As shown in FIG. 6, FIG. 7A, and FIG. 7B, the substrate 36 (see FIG. 6) of the air inlet unit 3 is connected to the substrate 23 (see FIG. 6) inside the instrument body 2 (each housing 21 and 22) via the wiring 40. That is, the wiring 40 connecting the substrates 23 and 36 is provided so as to straddle the boundary (fitting part) between the instrument body 2 and the air inlet unit 3. In the substrate 23, processing such as generation of musical sound signals is performed based on the detection result of exhaled air by the temperature sensor 360 (see FIG. 4) of the substrate 36.

As described above, the air inlet side housing 32 and the exhaust side housing 33 of the air inlet unit 3 include the large diameter portions 320 and 330 and the small diameter portions 321 and 331, and barrier walls 321c and 331c are formed on the inner circumferential side of the small diameter portions 321 and 331 of each housing 32 and 33. These barrier walls 321c and 331c are abutted against each other by stacking the housings 32 and 33 (for the barrier wall 331c before stacking the housings 32 and 33, see FIG. 2). In a state where the barrier walls 321c and 331c are abutted against each other, the internal space S1 of the air inlet unit 3 (see FIG. 6 or FIG. 7B) and the internal space S3 of the instrument body 2 (see FIG. 6 or FIG. 7B) are partitioned.

The barrier walls 321c and 331c are formed with notches 321d and 331d that cut out a portion of the respective abutting surfaces (for the point that the notch 331d is formed on the abutting surface of the barrier wall 331c, see FIG. 2), and in a state where the barrier walls 321c and 331c are abutted against each other, a penetrating hole for passing the wiring 40 is formed by the notches 321d and 331d. A cylindrical member 41 made of rubber or elastomer is mounted in the penetrating hole formed by the notches 321d and 331d.

The cylindrical member 41 is formed in a cylindrical shape having a penetrating hole 410 on the inner circumferential side, and disc-shaped flanges 411 project toward the outer circumferential side from two ends in the axial direction of the cylindrical member 41. In a state where the wiring 40 is inserted into the penetrating hole 410 of the cylindrical member 41, the flanges 411 are hooked onto the barrier walls 321c and 331c (edges of the notches 321d and 331d).

Thus, in this embodiment, notches 321d and 331d (penetrating holes) are formed in the barrier walls 321c and 331c that partition the internal space S1 of the air inlet unit 3 and the internal space S3 of the instrument body 2, and the wiring 40 is passed through the notches 321d and 331d. This enables the substrates 23 and 36 (see FIG. 6) of the instrument body 2 and the air inlet unit 3 to be connected by the wiring 40, while the flow of exhaled air from the air inlet unit 3 (internal space S1) toward the instrument body 2 (internal space S3) side may be blocked by the barrier walls 321c and 331c. This may suppress moisture contained in the exhaled air from adhering to the substrate 23 of the instrument body 2, so damage to the substrate 23 may be suppressed.

Further, in this embodiment, since the structure is such that the cylindrical member 41 (elastic body) that bundles multiple wirings 40 is mounted in the notches 321d and 331d, the flow of exhaled air from the air inlet unit 3 toward the instrument body 2 side may be effectively blocked by the cylindrical member 41. Thus, moisture contained in the exhaled air may be more effectively suppressed from adhering to the substrate 23 of the instrument body 2.

As described above, the protrusion 210 of the instrument body 2 (upper housing 21) is inserted into the insertion hole 30 formed in the air inlet unit 3 (small diameter portions 321 and 331), and the wiring 40 is passed through the space between inner circumferential surfaces of the small diameter portions 321 and 331 of the air inlet unit 3 and the protrusion 210 (see FIG. 7B). For this reason, for example, in a structure where the air inlet unit 3 may rotate unlimitedly with respect to the instrument body 2, the wiring 40 becomes easily entangled with the protrusion 210.

In the case of such entanglement of the wiring 40 occurring, there is a risk that the wiring 40 itself may be disconnected or the wiring 40 may become detached from the substrates 23 and 36. Thus, in this embodiment, a structure is adopted in which the rotation of the air inlet unit 3 is restricted at a predetermined angle by the inner circumferential protrusions 211 and 221 of the instrument body 2 (see FIG. 7A).

The inner circumferential protrusion 211 is a protrusion formed on the inner circumferential surface of the upper housing 21 of the instrument body 2, and the inner circumferential protrusion 221 is a protrusion formed on an inner circumferential surface of the lower housing 22. An outer circumferential protrusion 321e (see FIG. 7A) protrudes toward the outer circumferential side from the outer circumferential surface of the small diameter portion 321 of the air inlet unit 3 (air inlet side housing 32), and the outer circumferential protrusion 321e is inserted between the pair of inner circumferential protrusions 211 and 221 arranged in the circumferential direction.

In response to rotating the air inlet unit 3 with respect to the instrument body 2, the rotation of the air inlet unit 3 is restricted by the outer circumferential protrusion 321e contacting one of the pair of inner circumferential protrusions 211 and 221. In this embodiment, the rotation angle of the air inlet unit 3 (hereinafter referred to as “movable range of the air inlet unit 3”) from the state where the outer circumferential protrusion 321e is in contact with one inner circumferential protrusion 211 (the state in FIG. 7A) until the outer circumferential protrusion 321e contacts the other inner circumferential protrusion 221 is set to approximately 40°.

Thus, in this embodiment, the relative rotation between each housing 21 and 22 (first cylinder portion) of the instrument body 2 and the small diameter portions 321 and 331 (second cylinder portion) of each housing 32 and 33 of the air inlet unit 3 is restricted at a predetermined angle (within a range of 40°) by contact of the inner circumferential protrusions 211 and 221 and the outer circumferential protrusion 321e (first stopper). Accordingly, even in the case of the substrates 23 and 36 (see FIG. 6) of the instrument body 2 and the air inlet unit 3 being connected by the wiring 40, entanglement of multiple wirings 40 with each other and entanglement of the wiring 40 with the protrusion 210 during rotation of the air inlet unit 3 may be suppressed. Thus, damage to the wiring 40 may be suppressed.

In response to rotating the air inlet unit 3 with respect to the instrument body 2, the protrusion 210 slides along the insertion hole 30 extending in the circumferential direction. That is, the insertion hole 30 is an elongated hole whose dimension in the circumferential direction is larger than the diameter of the protrusion 210. On the other hand, the width dimension of the insertion hole 30 in the axial direction (left-right direction in FIG. 6 or up-down direction in FIG. 7B) is formed to be substantially the same as (or slightly larger than) the diameter of the protrusion 210, and the gap between an inner circumferential surface of the insertion hole 30 and the protrusion 210 in the axial direction is minimal (or they are in contact). Accordingly, positional displacement in the axial direction and detachment of the air inlet unit 3 with respect to the instrument body 2 may be restricted by engagement of the insertion hole 30 and the protrusion 210 (second stopper). Accordingly, the electronic wind instrument 1 may be stably performed.

Since the bolt B1 (see FIG. 6 or FIG. 7A) for fixing each housing 21 and 22 of the instrument body 2 is fastened to the protrusion 210, the rigidity of the protrusion 210 may be enhanced by the bolt B1. Thus, even in the case of a load due to displacement in the axial direction of the air inlet unit 3 acting on the protrusion 210, damage to the protrusion 210 may be suppressed.

Further, rib-shaped convex portions 210a (see FIG. 7B) are formed on the outer circumferential surface of the protrusion 210, and although not illustrated, the convex portions 210a extend over two ends in the longitudinal direction (perpendicular direction to the paper surface in FIG. 7B) of the cylindrical protrusion 210. Since the convex portions 210a are formed in a pair on the outer circumferential surfaces on two sides of the protrusion 210 (in the axial direction of the air inlet unit 3), the rigidity of the protrusion 210 against loads in the axial direction of the air inlet unit 3 may be effectively enhanced. Thus, damage to the protrusion 210 due to such loads may be suppressed.

Thus, in order to restrict displacement in the axial direction of the air inlet unit 3 by the protrusion 210, it is preferable to make the gap between the inner circumferential surface of the insertion hole 30 and the protrusion 210 in the axial direction as narrow as possible. On the other hand, the narrower the gap, the more likely friction occurs at the sliding part between the inner circumferential surface of the insertion hole 30 and the protrusion 210 in response to rotating the air inlet unit 3 with respect to the instrument body 2. In the case of this friction becoming large, the air inlet unit 3 cannot be smoothly rotated with respect to the instrument body 2.

Further, in response to the performer rotating the air inlet unit 3, a force in a direction that tilts the axis of the air inlet unit 3 with respect to the axis of the instrument body 2 may act. In the case of such a force acting, friction at the sliding part between the insertion hole 30 and the protrusion 210 becomes large, so smooth rotation of the air inlet unit 3 is likely to be impeded.

In contrast, this embodiment includes annular O-rings 39 (see FIG. 6 or FIG. 7B) that seal the gap between an inner circumferential surface of the instrument body 2 and the outer circumferential surface of the air inlet unit 3, and these O-rings 39 are provided in a pair on two sides in the axial direction of the air inlet unit 3 sandwiching the protrusion 210. Accordingly, in response to rotating the air inlet unit 3, even in the case of the above-described force that tilts the axis of the air inlet unit 3 acting, deviation of the axis of the air inlet unit 3 with respect to the axis of the instrument body 2 may be effectively restricted by the pair of O-rings 39. By restricting such axial deviation of the air inlet unit 3 on two sides of the protrusion 210 (in the axial direction of the air inlet unit 3), friction at the sliding part between the insertion hole 30 and the protrusion 210 may be reduced, so the air inlet unit 3 may be smoothly rotated with respect to the instrument body 2.

Further, in a cross-sectional view including the axis of the instrument body 2 (air inlet unit 3), the O-ring 39 is formed in a semicircular shape, and the bottom surfaces of the grooves 321b and 331b (see FIG. 6 or FIG. 7B) in which the O-ring 39 is mounted are formed in a planar shape. Accordingly, the bottom surfaces of the grooves 321b and 331b and the O-ring 39 may be brought into surface contact with each other, so twisting of the O-ring 39 due to friction (friction between the inner circumferential surface of the instrument body 2 and the outer circumferential surface of the O-ring 39) in response to rotating the air inlet unit 3 may be suppressed. By suppressing twisting of the O-ring 39, the function of preventing deviation of the axis of the air inlet unit 3 as described above may be reliably exhibited by the O-ring 39, and damage to the O-ring 39 may be suppressed.

Here, the rotation angle of the air inlet unit 3 with respect to the instrument body 2 may also be restricted by contact between two ends of the insertion hole 30 in the circumferential direction and the protrusion 210. However, in such a configuration, in addition to the load accompanying displacement in the axial direction of the air inlet unit 3, a load in the rotation direction of the air inlet unit 3 acts on the small diameter portions 321 and 331 (end portions in the circumferential direction of the insertion hole 30) and the protrusion 210, so it is necessary to increase the rigidity of the small diameter portions 321 and 331 and the protrusion 210 accordingly.

In order to ensure the rigidity of such small diameter portions 321 and 331 and the protrusion 210, configurations such as shortening the dimension in circumferential direction of the insertion hole 30 (reducing the opening area of the insertion hole 30) or increasing the diameter of the protrusion 210 could be adopted. However, in such configurations, it is necessary to shorten the movable range of the protrusion 210 in the circumferential direction. Thus, a wide movable range of the air inlet unit 3 may not be ensured.

Further, in order to ensure the rigidity of the small diameter portions 321 and 331 and the protrusion 210, for example, it could be considered to increase the diameter of the instrument body 2 and the air inlet unit 3 itself. However, in such a configuration, the electronic wind instrument 1 may not simulate a slender instrument such as a flute.

In contrast, in this embodiment, rotation of the air inlet unit 3 is restricted by the inner circumferential protrusions 211 and 221 and the outer circumferential protrusion 321e (see FIG. 7A), and in a state where the inner circumferential protrusions 211 and 221 and the outer circumferential protrusion 321e are in contact (a state where rotation of the air inlet unit 3 is restricted), a gap S4 (see FIG. 7A or FIG. 7B) is formed between the end portion in the circumferential direction of the insertion hole 30 and the protrusion 210. Accordingly, a load in the rotation direction of the air inlet unit 3 acting on the protrusion 210 may be suppressed.

It is noted that FIG. 7A illustrates a state where the gap S4 is formed between the end portion in the circumferential direction of the insertion hole 30 and the protrusion 210 in a state where the outer circumferential protrusion 321e is in contact with the inner circumferential protrusion 211, but a similar gap is formed even in the case where the outer circumferential protrusion 321e is in contact with the inner circumferential protrusion 221. In this way, by adopting a structure in which a load in the rotation direction of the air inlet unit 3 does not act on the protrusion 210, the rigidity required for the small diameter portions 321 and 331 and the protrusion 210 may be made relatively small. Thus, it is possible to eliminate the need to shorten the dimension in circumferential direction of the insertion hole 30 or increase the diameter of the protrusion 210 in order to ensure such rigidity, so a wide movable range of the air inlet unit 3 may be ensured.

Further, it is unnecessary to increase the diameter of the instrument body 2 and the air inlet unit 3 itself in order to enhance the rigidity of the small diameter portions 321 and 331 and the protrusion 210. Thus, since the instrument body 2 and the air inlet unit 3 may be formed in a slender shape, the electronic wind instrument 1 may simulate a slender instrument such as a flute.

In this way, the width of the movable range of the air inlet unit 3 (the dimension in the circumferential direction of the insertion hole 30 and the size of the diameter of the protrusion 210) affects the rigidity and diameter size of the instrument body 2 and the air inlet unit 3. Thus, for example, in the case where the movable range of the air inlet unit 3 exceeds 50°, it becomes difficult to reduce the diameter while providing the instrument body 2 and the air inlet unit 3 with necessary rigidity. On the other hand, in the case where the movable range of the air inlet unit 3 is less than 30°, a sufficient adjustment range for the orientation of the air inlets 310 and 311 (see FIG. 1A and FIG. 1B) may not be ensured.

Thus, the movable range of the air inlet unit 3 is preferably 30° or more and 50° or less (40° in this embodiment as described above). By making the movable range of the air inlet unit 3 50° or less, it is possible to reduce the diameter of the instrument body 2 and the air inlet unit 3 while providing necessary rigidity to each of their housings. Further, by making the movable range of the air inlet unit 3 30° or more, a sufficient adjustment range for the orientation of the air inlets 310 and 311 may be ensured. However, the movable range of the air inlet unit 3 may be less than 30° or may exceed 50°.

Here, as shown in FIG. 6, the end surfaces 212 and 222 of the respective housings 21 and 22 of the instrument body 2 in the axial direction are abutted against the end surfaces 327 and 336 of the large diameter portions 320 and 330 of the air inlet unit 3 (respective housings 32 and 33) in the same direction, and a boundary line L between the instrument body 2 and the air inlet unit 3 is formed at this abutting part. Since this boundary line L is covered by a cylindrical covering material 42 mounted on the outer circumferential surfaces of the instrument body 2 and the air inlet unit 3, the appearance of the electronic wind instrument 1 may be improved.

On the outer circumferential surfaces of the respective housings 21 and 22 of the instrument body 2, steps 213 and 223 are formed in regions including the end surfaces 212 and 222 thereof, and on the outer circumferential surfaces of the large diameter portions 320 and 330 of the air inlet unit 3, steps 328 and 337 are also formed in regions including the end surfaces 327 and 336 thereof. These steps 213, 223, 328, and 337 are indentations extending in the circumferential direction over the entire circumference of the outer circumferential surfaces of the instrument body 2 and the air inlet unit 3, and the covering material 42 is mounted in these steps 213, 223, 328, and 337.

The covering material 42 is formed using stretchable fabric (woven fabric), and in the case of mounting the covering material 42 to the steps 213, 223, 328, and 337, the inner diameter of the covering material 42 is expanded, and the covering material 42 is moved to the steps 213, 223, 328, and 337 while passing through the inner circumferential side of the covering material 42 from the head side (the end portion on the opposite side to the instrument body 2) of the air inlet unit 3. In this mounted state of the covering material 42, movement of the covering material 42 in the axial direction is restricted by the steps 213, 223, 328, and 337, so positional displacement of the covering material 42 may be prevented.

Since such a fabric covering material 42 has water absorbency, moisture such as saliva that has traveled from the air inlets 310 and 311 (see FIG. 1A and FIG. 1B) along the outer circumferential surface toward the instrument body 2 side may be absorbed by the covering material 42. This may suppress moisture from infiltrating into the interior of the instrument body 2 through gaps such as the mounting parts of the keys 20 (see FIG. 1A and FIG. 1B) of the instrument body 2, so adhesion of moisture to internal components of the instrument body 2 such as the substrate 23 may be suppressed.

It is noted that the covering material 42 may be formed using a hard material such as resin or metal, rather than such a stretchable material. In the case of forming the covering material 42 using such a hard material, the steps 213, 223, 328, and 337 formed in the above-described mounting region of the covering material 42 (the region including the boundary line L) are omitted, and the covering material 42 is configured to be slidable from the head side of the air inlet unit 3 to the mounting region, and the covering material 42 may be fixed to the outer circumferential surface of the instrument body 2 or the air inlet unit 3 by bolts or the like. By fixing such a hard covering material 42 to the region including the boundary line L between the instrument body 2 and the air inlet unit 3, expansion of such boundary part (abutting surface) may be restricted by the covering material 42.

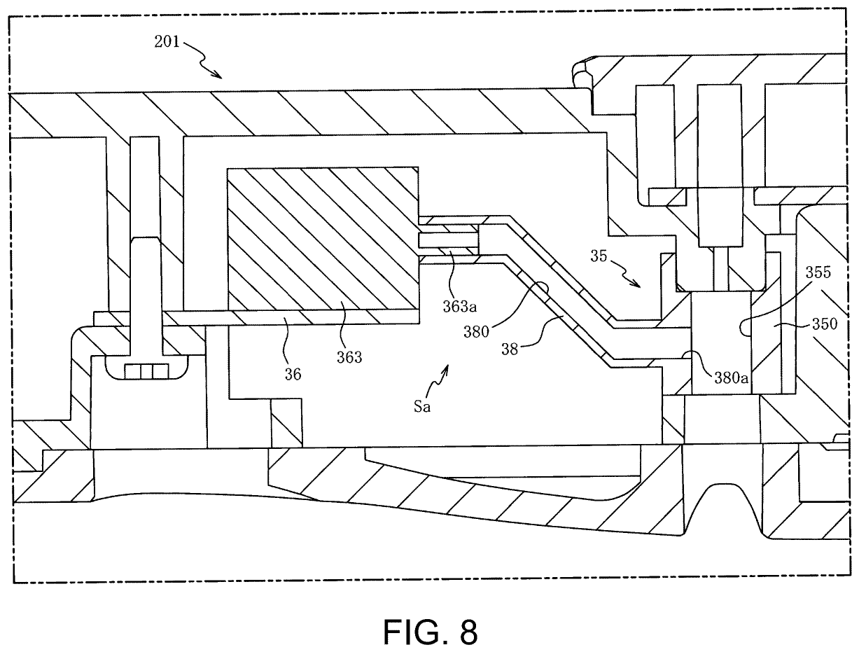

Next, the electronic wind instrument 201 of the second embodiment will be described with reference to FIG. 8. In the first embodiment, the case of detecting temperature change of air in the branch flow path 356 heated by the heater 362 with the temperature sensor 360 was described, but in the second embodiment, the case of detecting change in airflow (air pressure) in the branch flow path 380 using the pressure sensor 363 will be described. It is noted that the same reference numerals are assigned to the same portions as in the above-described first embodiment, and description thereof will be omitted.

As shown in FIG. 8, the sensor module Sa of the electronic wind instrument 201 of the second embodiment is provided with a pressure sensor 363 instead of the temperature sensor 360 and heater 362 (see FIG. 4) described in the first embodiment, and a cylindrical conduit 38 is provided instead of each wall portion 351 to 353 (see FIG. 4) of the case 35. The pressure sensor 363 is a sensor that detects changes in air pressure, and since a known configuration may be adopted, detailed description will be omitted.

The pressure sensor 363 is mounted on the upper surface of the substrate 36, and the pressure sensor 363 is formed with a cylindrical connection port 363a. One end of the conduit 38 is connected to the connection port 363a, and the other end of the conduit 38 is connected to the cylinder portion 350 of the case 35. It is noted that the conduit 38 may be formed integrally with the case 35 (cylinder portion 350), or may be a separate pipe from the case 35 (e.g., a flexible tube).

The cavity inside the conduit 38 is configured as a branch flow path 380, and an opening 380a of this branch flow path 380 is formed on an inner circumferential surface of the cylinder portion 350 (case side flow path 355). That is, also in this embodiment, the branch flow path 380 branches so as to intersect with the case side flow path 355. In response to a change in the flow rate (flow velocity) of exhaled air flowing in the main flow path (case side flow path 355), a change also occurs in the airflow generated in the branch flow path 380 (sub flow path branching from the main flow path), and this change in airflow (air pressure) in the branch flow path 380 is detected by the pressure sensor 363.

Also in this embodiment, the cross-sectional area of the opening 380a of the branch flow path 380 is formed smaller than the cross-sectional area of the part (case side flow path 355) where the opening 380a of the branch flow path 380 is connected in the main flow path. This provides an effect that exhaled air containing moisture becomes difficult to flow into the pressure sensor 363 side. Factors for obtaining this effect include that exhaled air passing through the case side flow path 355 becomes difficult to flow into the branch flow path 380 side, and that negative pressure is generated in the branch flow path 380 by exhaled air passing through the case side flow path 355, and air in the branch flow path 380 is sucked from the opening 380a into the case side flow path 355 by the negative pressure.

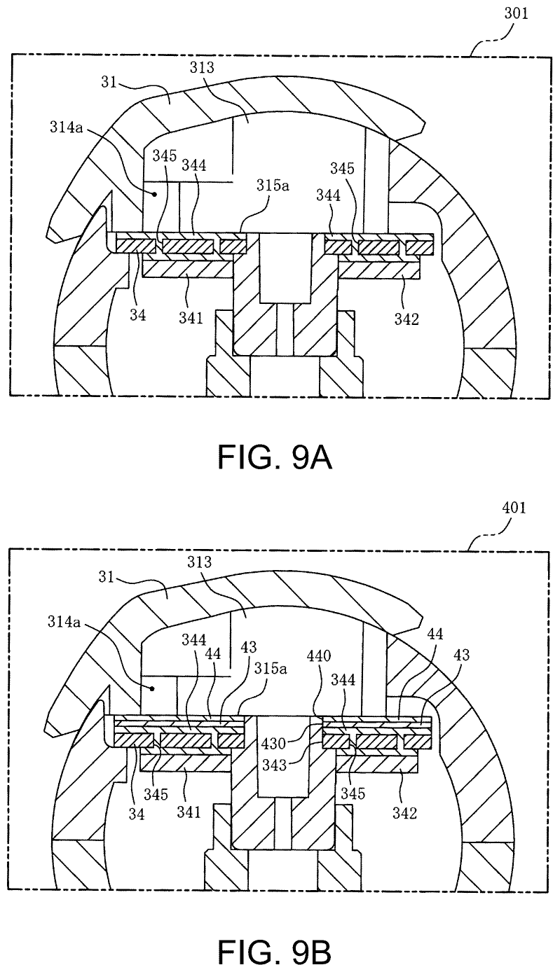

Next, electronic wind instruments 301 and 401 of the third embodiment and fourth embodiment will be described with reference to FIG. 9A and FIG. 9B. In each of the above-described embodiments, the case where the substrate 34 to which the heater 341 is mounted is a single-sided substrate has been described, but in the third and fourth embodiments, the case where the substrate 34 is a double-sided substrate having a conductor pattern 344 will be described. It is noted that the same parts as those in each of the above-described embodiments are given the same reference numerals and description thereof will be omitted.

FIG. 9A is a partially enlarged cross-sectional view of the electronic wind instrument 301 of the third embodiment, and FIG. 9B is a partially enlarged cross-sectional view of the electronic wind instrument 401 of the fourth embodiment. It is noted that FIG. 9A and FIG. 9B illustrate a cross-section corresponding to FIG. 5A. Further, in FIG. 9A and FIG. 9B, the conductor pattern 344 and through holes 345 of the substrate 34 are schematically illustrated for ease of understanding.

As shown in FIG. 9A, in the electronic wind instrument 301 of the third embodiment, a conductive conductor pattern 344 is formed on the front surface of the substrate 34. The conductor pattern 344 is an electrical extension of a circuit (wiring) that electrically connects the heater 341, temperature sensor 342, temperature control device, power source, and the like, and is formed by etching copper foil covering the substrate 34. Multiple through holes 345 and metal plating to inner circumferential surfaces of the through holes 345 are formed in the substrate 34 to connect the conductor pattern 344 to the heater 341 and temperature sensor 342. The through holes 345 are penetrating holes penetrating in the thickness direction of the substrate 34, and by applying metal plating to the inner circumferential surfaces of the through holes 345, the conductor pattern 344 on the front surface of the substrate 34 and the circuit (wiring) on the back surface are electrically connected, and heat is transferred.

On the front surface side of the substrate 34, similar to each of the above-described embodiments, each bent flow path 314a and 315a surrounded by the substrate 34 and the barrier wall 313 of the lip plate 31 is formed, and the conductor pattern 344 of the substrate 34 is formed at positions facing these bent flow paths 314a and 315a. Since the conductor pattern 344 has higher thermal conductivity property than the barrier wall 313 of the lip plate 31 and other portions of the substrate 34 (portions where the conductor pattern 344 is not formed), by heating the substrate 34 having such conductor pattern 344 (heat transfer material) formed on the front surface with the heater 341, the front surface of the substrate 34 (inner wall surfaces of the bent flow paths 314a and 315a) may be efficiently heated. Thus, accumulation of moisture in the bent flow paths 314a and 315a may be suppressed.

In this way, in the case of aiming to form the bottom surfaces of the bent flow paths 314a and 315a with a material having high thermal conductivity property (heat transfer material), it is also possible to form the bottom surfaces of the bent flow paths 314a and 315a by a metal plate 44 stacked on the front surface side of the substrate 34 (making the metal plate 44 function as a heat transfer material), for example, as in the fourth embodiment described later.

In contrast, in this embodiment, the bottom surfaces of the bent flow paths 314a and 315a are formed by the substrate 34, and the bent flow paths 314a and 315a are heated using the conductor pattern 344 formed on the front surface of this substrate 34 (making the conductor pattern 344 function as a heat transfer material). This enables the metal plate 44 as in the fourth embodiment to be unnecessary, so the number of parts may be reduced. Furthermore, since the through holes 345 that electrically connect the heater 341 and the conductor pattern 344 are formed in the substrate 34, heat from the heater 341 is easily transferred to the conductor pattern 344 via the through holes 345. This enables the front surface of the substrate 34 to be heated more efficiently, so accumulation of moisture in the bent flow paths 314a and 315a may be suppressed.

As shown in FIG. 9B, the electronic wind instrument 401 of the fourth embodiment has the same configuration as the electronic wind instrument 301 of the third embodiment, except that the heat transfer sheet 43 and the metal plate 44 are sequentially stacked on the front surface of the substrate 34. The heat transfer sheet 43 is a resin heat dissipation material containing thermal conductive fillers such as ceramics or metals, and since a known configuration may be adopted, detailed description is omitted.

The heat transfer sheet 43 is formed in a sheet shape having adhesiveness on both upper and lower surfaces, and the front surface of the substrate 34 and the back surface of the metal plate 44 are bonded via the heat transfer sheet 43. The metal plate 44 is formed in a plate shape using metal such as aluminum, and each of the heat transfer sheet 43 and the metal plate 44 is formed with notches 430 and 440 having shapes corresponding to the notch 343 of the substrate 34 (regarding the shape of the notch 343, see FIG. 2).

Although not shown, substantially the entire front surface of the substrate 34 is covered by the heat transfer sheet 43 and the metal plate 44, and in this embodiment, the walls of the bent flow paths 314a and 315a (mounting walls to which the heater 341 is mounted) are formed by a laminated body in which the substrate 34, the heat transfer sheet 43, and the metal plate 44 are stacked. The barrier wall 313 of the lip plate 31 is abutted against the metal plate 44 laminated on the most front surface side of this wall, and this abutting part is joined by adhesive or the like in the same manner as in each of the above embodiments.

The metal plate 44 (heat transfer material) that forms the bottom surfaces of the bent flow paths 314a and 315a is formed to have higher thermal conductivity property than the barrier wall 313 of the lip plate 31 and the substrate 34 (parts where the conductor pattern 344 is not formed). By heating the substrate 34 stacked on the back surface side of this metal plate 44 with the heater 341, the inner wall surfaces of the bent flow paths 314a and 315a (front surface of the metal plate 44) may be efficiently heated. Thus, accumulation of moisture in the bent flow paths 314a and 315a may be suppressed.

Further, since the bent flow paths 314a and 315a are formed by the barrier wall 313 being abutted against the metal plate 44, substantially the entire bent flow paths 314a and 315a surrounded by the barrier wall 313 may be made to face the metal plate 44. Thereby, compared to the case where the conductor pattern 344 formed in a partial region of the front surface of the substrate 34 is made to face the bent flow paths 314a and 315a as in the third embodiment described above, the inner wall surfaces of the bent flow paths 314a and 315a may be efficiently heated by the metal plate 44. Thus, accumulation of moisture in the bent flow paths 314a and 315a may be suppressed.

Further, since the substrate 34 is stacked on the back surface side of the metal plate 44 that forms the bottom surfaces of the bent flow paths 314a and 315a, and the heater 341 is mounted on the back surface of this substrate 34, exposure of the substrate 34 to the bent flow paths 314a and 315a side may be suppressed compared to the case where the bottom surfaces of the bent flow paths 314a and 315a are formed by the substrate 34 as in the third embodiment. Thereby, contact of breath containing moisture and moisture in the bent flow paths 314a and 315a with the substrate 34 may be suppressed, so damage to the substrate 34 may be suppressed.

Further, since the substrate 34 includes the conductor pattern 344 formed on its front surface and the through holes 345 that connect the conductor pattern 344 to the heater 341, heat from the heater 341 is easily transmitted to the metal plate 44 via the through holes 345 and the conductor pattern 344. Thereby, the inner wall surfaces of the bent flow paths 314a and 315a may be efficiently heated by the metal plate 44, so accumulation of moisture in the bent flow paths 314a and 315a may be suppressed.

Further, since the heat transfer sheet 43 sandwiched between the substrate 34 and the metal plate 44 is softer (has lower hardness) than the substrate 34 and the metal plate 44, the heat transfer sheet 43 may be brought into close contact with the front surface of the substrate 34 and the back surface of the metal plate 44 without gaps. Since the thermal conductivity of the heat transfer sheet 43 is higher than the thermal conductivity property of the barrier wall 313 and the substrate 34 (portions where the conductor pattern 344 is not formed), heat from the heater 341 may be efficiently transmitted to the metal plate 44 via the heat transfer sheet 43. Thereby, the inner wall surfaces of the bent flow paths 314a and 315a may be efficiently heated by the metal plate 44, so accumulation of moisture in the bent flow paths 314a and 315a may be suppressed.

Furthermore, since heat from the heater 341 is transmitted to the heat transfer sheet 43 via the conductor pattern 344 and the through holes 345 of the substrate 34, heat from the heater 341 is easily transmitted to the metal plate 44 via the heat transfer sheet 43. Thereby, the inner wall surfaces of the bent flow paths 314a and 315a may be efficiently heated by the metal plate 44, so accumulation of moisture in the bent flow paths 314a and 315a may be suppressed.

The above description has been made based on the above embodiments, but the disclosure is not limited to the above embodiments in any way, and it is easily inferred that various improvements and modifications are possible within the scope that does not depart from the spirit of the disclosure.

In each of the above embodiments, the case where the electronic wind instruments 1, 201, 301, and 401 are electronic musical instruments that imitate a flute has been described, but the disclosure is not necessarily limited thereto. For example, the electronic wind instruments 1, 201, 301, and 401 may imitate other wind instruments (saxophone, clarinet, recorder, hulusi, etc.).

As an example of an electronic wind instrument that imitates other wind instruments of this type, those described in International Publication No. WO 2019/224996 and Japanese Patent Application Laid-Open Publication No. 2021-039261 are exemplified. Even in such electronic wind instruments, in the case where a sensor that detects exhaled air inside a mouthpiece (cylindrical body) and a substrate provided inside the instrument body are connected by wiring, it is preferable to apply a rotation structure similar to the air inlet unit 3 (cylindrical body) described in each of the above embodiments, and regulate the rotation angle of the mouthpiece (cylindrical body) relative to the instrument body at a predetermined angle. Thereby, damage to the wiring connecting the sensor and the substrate during rotation of the mouthpiece may be suppressed.

In each of the above embodiments, the case where the main flow path is composed of the first bent flow path 314a, the second bent flow path 315a, the housing side flow path 323a, the restricted flow path 326, and the case side flow path 355 has been described, but the disclosure is not necessarily limited thereto. For example, among the connection parts of the respective flow paths 314a, 315a, 323a, 326, and 355, another flow path may be added to some or all of the connection parts, or a portion of each flow path 314a, 315a, 323a, 326, and 355 may be bent. That is, the shape of the main flow path connecting from each air inlet 310 and 311 to the first exhaust port 334 may be arbitrarily changed, and the disclosure may be applied to any electronic wind instrument that includes at least a branch flow path that branches so as to intersect with the main flow path.

In each of the above embodiments, the case where the case side flow path 355, which is a portion of the main flow path, is formed by the case 35 of the sensor modules Sa and Sb (the sensor modules Sa and Sb include a portion of the main flow path) has been described, but the disclosure is not necessarily limited thereto. For example, in addition to the case side flow path 355, the sensor modules Sa and Sb may include some or all of the first bent flow path 314a, the second bent flow path 315a, the housing side flow path 323a, and the restricted flow path 326. That is, portions of the lip plate 31, the air inlet side housing 32 (e.g., the mounting hole 322 and the lower protrusion 325), and a portion or all of the substrate 34 that form the main flow path may be used as components of the sensor modules Sa and Sb.

In each of the above embodiments, the case where the first bent flow paths 314a and 314b and the second bent flow paths 315a and 315b are formed in the lip plate 31 has been described, but the disclosure is not necessarily limited thereto. For example, either one of the first bent flow paths 314a and 314b and the second bent flow paths 315a and 315b may be omitted, and each air inlet 310 and 311 and the housing side flow paths 323a and 323b may be connected via the other bent flow path. Further, both the first bent flow paths 314a and 314b and the second bent flow paths 315a and 315b may be omitted, and each air inlet 310 and 311 and the housing side flow paths 323a and 323b may be connected linearly.

In each of the above embodiments, the case where the restricted flow paths 316a and 326 are formed in the middle of each bent flow path 314a and 315a or between the housing side flow path 323a and the case side flow path 355 (i.e., in the main flow path on the upstream side of the branch flow path) has been described, but the disclosure is not necessarily limited thereto. For example, either one or both of the restricted flow paths 316a and 326 may be omitted, or a restricted flow path may be formed in the case side flow path 355 (i.e., in the case 35).

In each of the above embodiments, the case where the leak flow path 322b is formed in the second bent flow path 315a (the main flow path on the upstream side of the branch flow path) has been described, but the disclosure is not necessarily limited thereto. For example, a configuration that omits the leak flow path 322b (sealing the gap between the substrate 34 and the air inlet side housing 32) may be used, or a flow path corresponding to the leak flow path 322b may be formed in other parts of the main flow path.

That is, the flow path of exhaled air from each air inlet 310 and 311 to the temperature sensor 360 and the pressure sensor 363 (first exhaust port 334) is not limited to the flow path described in each of the above embodiments, and the shape (route) of the flow path may be formed arbitrarily.

In each of the above embodiments, the case where the first and second exhaust ports 334 and 335 are formed in the exhaust side housing 33 has been described, but the disclosure is not necessarily limited thereto. For example, an exhaust port corresponding to the first exhaust port 334 (i.e., an exhaust port that exhausts exhaled air from the main flow path) may be formed in the air inlet side housing 32, or an exhaust port for ventilating the internal space S1 of each housing 32 and 33 may be formed in the air inlet side housing 32 by omitting the second exhaust port 335 (or in addition to the second exhaust port).

In each of the above embodiments, the case where the opening dimension in the circumferential direction of the second exhaust port 335 expands toward the outer circumferential side has been described, but the disclosure is not necessarily limited thereto. For example, the opening dimension in the circumferential direction of the second exhaust port 335 may be constant from the inner circumferential side to the outer circumferential side, or may narrow from the inner circumferential side to the outer circumferential side.

In each of the above embodiments, the case where each exhaust port 334 and 335 and the recess portion 333b are covered by the decorative body 37 in which the first to third covering portions 370 to 372 are integrally formed has been described, but the disclosure is not necessarily limited thereto. For example, the first to third covering portions 370 to 372 may be formed separately, or part or all of the first to third covering portions 370 to 372 may be omitted.

In each of the above embodiments, the case where the second exhaust port 335 is covered by the second covering portion 371 extending in the axial direction has been described, but the disclosure is not necessarily limited thereto. For example, similar to the first covering portion 370 and the third covering portion 372, the second exhaust port 335 may be covered with a covering portion having a penetrating hole penetrating in the radial direction, or the first exhaust port 334 and the recess portion 333b may be covered by a covering portion extending in the axial direction.

In each of the above embodiments, the case where a pair of inclined surfaces 371a are formed on the inner circumferential surface of the second covering portion 371 so as to be arranged via a ridge line has been described, but the disclosure is not necessarily limited thereto. For example, a flat surface or a curved surface may be formed at the boundary part between the pair of inclined surfaces 371a, or the inner circumferential surface of the second covering portion 371 may be a flat surface.

In each of the above embodiments, bolts B1, B2, and B3 are used to fix the members constituting the electronic wind instruments 1, 201, 301, and 401 to each other, but other screw parts or fastening parts may be used.

In each of the above embodiments, the case where each housing 32 and 33 of the air inlet unit 3 is inserted into the inner circumferential side of each housing 21 and 22 of the instrument body 2 has been described, but a configuration in which each housing 21 and 22 of the instrument body 2 is inserted into the inner circumferential side of each housing 32 and 33 of the air inlet unit 3 may also be used.

Further, regarding the cylindrical parts (first cylinder portion and second cylinder portion) of the instrument body 2 and the air inlet unit 3 at this insertion part, in each of the above embodiments, the case where a cylinder portion (first cylinder portion) is formed by the two housings 21 and 22 of the instrument body 2, and a cylindrical cylinder portion (second cylinder portion) is formed by the two housings 32 and 33 (small diameter portions 321 and 331) of the air inlet unit 3 has been described, but the disclosure is not necessarily limited thereto. For example, either one or both of the cylinder portions (first cylinder portion and second cylinder portion) of the instrument body 2 and the air inlet unit 3 may be configured from a single housing.

In each of the above embodiments, the case where the displacement of the air inlet unit 3 in the axial direction is regulated by the protrusion 210, while the rotation of the air inlet unit 3 is regulated by the outer circumferential protrusion 321e (inner circumferential protrusions 211 and 221) has been described, but the disclosure is not necessarily limited thereto. For example, the displacement of the air inlet unit 3 in the axial direction may be regulated by the outer circumferential protrusion 321e, or the rotation of the air inlet unit 3 may be regulated by the protrusion 210. Further, the stopper (second stopper) that regulates the displacement of the air inlet unit 3 in the axial direction may be omitted.

Further, instead of utilizing the protrusion 210 for fastening the housings 21 and 22 of the instrument body 2 together with the bolt B1, a configuration may be provided with dedicated irregularities for regulating the displacement of the air inlet unit 3 in the axial direction. As an example of such a configuration, a configuration is exemplified in which a recess portion is formed on one surface among the inner circumferential surface of the instrument body 2 (each housing 21 and 22) and the outer circumferential surface of the air inlet unit 3 (small diameter portions 321 and 331), while a convex portion that fits into the recess portion is formed on the other surface, and the displacement of the air inlet unit 3 in the axial direction is regulated by these irregularities.

In each of the above embodiments, the case where the rotation of the air inlet unit 3 is regulated by forming two inner circumferential protrusions 211 and 221 on each housing 21 and 22 of the instrument body 2, while forming one outer circumferential protrusion 321e on the air inlet side housing 32 (small diameter portion 321) of the air inlet unit 3 has been described, but the disclosure is not necessarily limited thereto. For example, two inner circumferential protrusions may be formed on either one of the housings among each housing 21 and 22 of the instrument body 2. Further, the rotation of the air inlet unit 3 may be regulated by forming one inner circumferential protrusion on the instrument body 2 side, while forming two outer circumferential protrusions on the air inlet unit 3 side.

In each of the above embodiments, the case where the protrusion 210 is formed in a cylindrical shape (circular cross-section) and the case where a rib-shaped convex portion 210a extending over two ends in the longitudinal direction of the protrusion 210 is formed have been described, but the disclosure is not necessarily limited thereto. For example, the cross-sectional shape of the protrusion 210 may be rectangular or other polygonal shapes, or the convex portion 210a of the protrusion 210 may be omitted.

In each of the above embodiments, the case where the pair of O-rings 39 are disposed on two sides (in the axial direction of the air inlet unit 3) sandwiching the protrusion 210 has been described, but the disclosure is not necessarily limited thereto. For example, the pair of O-rings 39 may be disposed on one side in the axial direction (e.g., the instrument body 2 side) relative to the protrusion 210, or may be disposed on the other side in the axial direction relative to the protrusion 210.

In each of the above embodiments, the case where the cross-sectional shape of the O-ring 39 is semicircular and the cross-sectional shape of the bottom surface of the grooves 321b and 331b is planar has been described, but the disclosure is not necessarily limited thereto. For example, the O-ring 39 may be formed with a circular cross-section, or the bottom surfaces of the grooves 321b and 331b may be formed in an arc shape.

In each of the above embodiments, the case where the boundary line L between the instrument body 2 and the air inlet unit 3 is covered by the covering material 42 having water absorption properties has been described, but the disclosure is not necessarily limited thereto. For example, the covering material 42 may be a material that does not have water absorption properties, or the covering material 42 may be omitted.

In each of the above embodiments, the case where the barrier walls 321c and 331c having the notches 321d and 331d (penetrating holes) are formed in the air inlet unit 3, and the cylindrical member 41 (elastic body) that bundles multiple wirings 40 is mounted to the notches 321d and 331d has been described, but the disclosure is not necessarily limited thereto. For example, walls corresponding to the barrier walls 321c and 331c may be formed on the instrument body 2 (each housing 21 and 22) side, or the cylindrical member 41 may be omitted and the wirings 40 may be passed directly through the notches 321d and 331d.

In each of the above embodiments, the case where the substrate 34 is mounted to the bottom surface 322a of the mounting hole 322 of the air inlet side housing 32 has been described, but the disclosure is not necessarily limited thereto. For example, the substrate 34 (heater 341) may be mounted to the inner circumferential surface of the air inlet side housing 32 on the opposite side from the bottom surface 322a, or the substrate 34 (heater 341) may be omitted. Further, a substrate (heater) for heating the case side flow path 355 and the branch flow path 380 may be separately provided.

In each of the above embodiments, the case where each bent flow path 314a and 315a, the restricted flow path 316a, the housing side flow path 323a, and the restricted flow path 326 are heated by the heater 341 has been described, but the disclosure is not necessarily limited thereto. As described above, since the shape (route) of the flow path from each air inlet 310 and 311 to the temperature sensor 360 and the pressure sensor 363 is arbitrary, the arrangement of the heater 341 (heating element) that heats the inner wall surface of the flow path is also arbitrary. Further, in each of the above embodiments, the case where the heater 341 is mounted to the back surface of the substrate 34 (the surface opposite to the bottom surface of the flow path) has been described, but the heater 341 may be mounted to the front surface of the substrate 34 (the bottom surface of the flow path).

In the first to third embodiments described above, the case where the substrate 34 (mounting wall) to which the heater 341 is mounted and the barrier wall 313 that abuts against the front surface of the substrate 34 (bottom surface of the flow path) are separate bodies, and the abutting portion of the barrier wall 313 against the substrate 34 is joined has been described, but the disclosure is not necessarily limited thereto. For example, a configuration may be adopted in which the mounting wall to which the heater 341 is mounted and the barrier wall that abuts against the mounting wall (bottom surface of the flow path) are fastened with fastening components such as bolts (without joining the abutting portion of the barrier wall), or the mounting wall and the barrier wall may be integrally formed.

In the first and second embodiments described above, the case where the barrier wall 313 of the lip plate 31 abuts against the front surface of the substrate 34 (single-sided substrate) that does not have the conductor pattern 344 has been described, but the disclosure is not necessarily limited thereto. For example, a configuration may be adopted in which the metal plate 44 of the fourth embodiment is sandwiched between the substrate 34 and the barrier wall 313 of the first and second embodiments. In the case of this configuration, the heat transfer sheet 43 may be provided between the substrate 34 and the metal plate 44, or the heat transfer sheet 43 may be omitted.

Further, in the case of forming each bent flow path 314a and 315a by abutting the barrier wall 313 against the metal plate 44, it is not necessarily required to stack the substrate 34 on the back surface side of the metal plate 44. For example, the substrate 34 may be provided at other portions of the instrument body 2 or the air inlet unit 3 (each housing 21, 22, 32, and 33), and the heater 341 electrically connected to the substrate 34 may be mounted to the back surface of the metal plate 44. Even in this configuration, since the metal plate 44 functions as a heat transfer material having higher thermal conductivity property than the barrier wall 313, the inner wall surface of each bent flow path 314a and 315a (front surface of the metal plate 44) may be efficiently heated by the heat of the heater 341.

In the first embodiment described above, the case where the protrusion portion 357 is formed on the inner circumferential surface of the case side flow path 355 (main flow path) has been described, but the disclosure is not necessarily limited thereto. For example, the protrusion portion 357 may be omitted, and the opening 356a of the branch flow path 356 may be formed on the inner circumferential surface of the case side flow path 355. Further, the protrusion portion 357 connected to the conduit 38 (branch flow path 380) may be formed on the inner circumferential surface of the case side flow path 355 of the second embodiment.

In the first embodiment described above, the case where the tapered surface 356c is formed in the branch flow path 356 has been described, but the disclosure is not necessarily limited thereto. For example, the tapered surface 356c may be omitted and the cross-sectional area of the branch flow path 356 may be constant over two ends in the axial direction, or a surface similar to the tapered surface 356c may be formed on the opening 356b side.

In the first embodiment described above, the case where the ventilation opening 333c that connects the opening 356b of the branch flow path 356 to the outside is formed in the boss 333 (recess portion 333b) has been described, but the disclosure is not necessarily limited thereto. For example, the opening 356b of the branch flow path 356 may be connected to the outside via a ventilation opening (exhaust port) provided in a part separate from the boss 333 (recess portion 333b).

In the fourth embodiment described above, the case where the heat transfer sheet 43 and the metal plate 44 are sandwiched between the barrier wall 313 and the substrate 34 has been described, but the heat transfer sheet 43 or the metal plate 44 may be omitted.

What is claimed is:

1. An electronic wind instrument comprising:
a housing;
an air inlet for exhaled air formed in the housing;
a flow path extending from the air inlet to an interior of the housing;
a sensor positioned in the flow path and configured to detect exhaled air; and
a heating element configured to heat the flow path on an upstream side of the sensor.

2. The electronic wind instrument according to claim 1, wherein the heating element is mounted on a back surface on an opposite side of an inner wall surface of the flow path.

3. The electronic wind instrument according to claim 1, wherein the flow path is formed by a mounting wall to which the heating element is mounted and a barrier wall that abuts against the mounting wall.

4. The electronic wind instrument according to claim 3, wherein the mounting wall constitutes at least a portion of an inner wall surface of the flow path and comprises a heat transfer material having a higher thermal conductivity than the barrier wall.

5. The electronic wind instrument according to claim 4, wherein the heat transfer material is a metal plate that constitutes the portion of the inner wall surface of the flow path.

6. The electronic wind instrument according to claim 5, wherein the mounting wall comprises a substrate that is stacked on a back surface side of the metal plate and to which the heating element is mounted on a back surface.

7. The electronic wind instrument according to claim 6, wherein the substrate comprises a conductor pattern formed on a front surface at a side of the metal plate and a through hole and metal plating to an inner circumferential surface of the through hole that connect the conductor pattern to the heating element.

8. The electronic wind instrument according to claim 6, wherein the mounting wall comprises a heat transfer sheet that is sandwiched between the metal plate and the substrate and is softer than the metal plate and the substrate, and
the heat transfer sheet has a higher thermal conductivity than the barrier wall.

9. The electronic wind instrument according to claim 4, wherein the mounting wall comprises a substrate that forms an inner wall surface of the flow path, and
the substrate comprises a conductor pattern formed on a front surface at a side of the flow path and configured as the heat transfer material, and a through hole and metal plating to an inner circumferential surface of the through hole that connect the conductor pattern to the heating element.

10. The electronic wind instrument according to claim 3, wherein an abutting portion of the barrier wall against the mounting wall is joined.

11. The electronic wind instrument according to claim 3, comprising a lip plate having the air inlet on an outer surface and mounted to the housing,
wherein the barrier wall is formed on an inner surface of the lip plate.

12. The electronic wind instrument according to claim 1, wherein the flow path comprises a bent flow path that is formed on the upstream side of the sensor and bends with respect to a blowing direction of exhaled air into the air inlet, and
the bent flow path is heated by the heating element.

13. The electronic wind instrument according to claim 1, wherein the flow path comprises a restricted flow path that is formed on the upstream side of the sensor and has a partially reduced cross-sectional area of the flow path, and
the restricted flow path is heated by the heating element.

14. The electronic wind instrument according to claim 1, wherein the flow path comprises a restricted flow path that is formed on the upstream side of the sensor and has a partially reduced cross-sectional area of the flow path, and
the flow path on an upstream side of the restricted flow path is heated by the heating element.

15. The electronic wind instrument according to claim 1, wherein a temperature of the heating element is controlled so that a temperature of an inner wall surface of the flow path becomes 30° C. or more and 45° C. or less.

16. A mounting method of a heating element in an electronic wind instrument that comprises a housing; an air inlet for exhaled air formed in the housing; a flow path extending from the air inlet to an interior of the housing; and a sensor positioned in the flow path and configured to detect exhaled air,
the mounting method of the heating element comprising mounting a heating element that heats the flow path on an upstream side of the sensor to a wall that surrounds the flow path.

17. The mounting method of the heating element in the electronic wind instrument according to claim 16, wherein the heating element is mounted on a back surface on an opposite side of an inner wall surface of the flow path.

18. The mounting method of the heating element in the electronic wind instrument according to claim 16, wherein the flow path is formed by a mounting wall and a barrier wall that abuts against the mounting wall, and the heating element is mounted to the mounting wall.

19. The mounting method of the heating element in the electronic wind instrument according to claim 18, wherein the mounting wall comprises a metal plate and a substrate stacked on a back surface side of the metal plate, and the heating element is mounted on a back surface of the substrate.

20. The mounting method of the heating element in the electronic wind instrument according to claim 18, wherein the mounting wall comprises a substrate that forms an inner wall surface of the flow path, and
the substrate comprises a conductor pattern formed on a front surface at a side of the flow path, and a through hole and metal plating to an inner circumferential surface of the through hole that connect the conductor pattern to the heating element.
